(19) United States
(12) Patent Application Publication
(10) Pub. No.: US 2025/0247825 A1
(43) Pub. Date: Jul. 31, 2025

(54) PAGING BY SEGMENTING PAGING IDENTITY

(71) Applicant: Samsung Electronics Co., Ltd., Suwon-si (KR)

(72) Inventors: Anil Agiwal, McKinney, TX (US); Shiyang Leng, Little Elm, TX (US); Kyeongin Jeong, Frisco, TX (US)

(21) Appl. No.: 19/033,321

(22) Filed: Jan. 21, 2025

Related U.S. Application Data
(60) Provisional application No. 63/627,498, filed on Jan. 31, 2024.
(60) Provisional application No. 63/669,369, filed on Jul. 10, 2024.
(60) Provisional application No. 63/674,587, filed on Jul. 23, 2024.

(51) Int. Cl. H04W 68/02; H04W 72/232

(52) U.S. Cl. CPC H04W 68/02; H04W 72/232

(57) ABSTRACT

A user equipment (UE) includes a processor. The processor is configured to segment a paging identity of the UE into a plurality of paging identity segments including at least a first paging identity segment and a second paging identity segment; determine a paging frame (PF) based on the first paging identity segment; and determine, based on the second paging identity segment, a paging occasion (PO) of the PF. The UE also includes a transceiver operatively coupled to the processor. The transceiver is configured to receive, in one of the determined PO or a paging early indication-occasion (PEI-O), a first physical download control channel (PDCCH) transmission including first downlink control information (DCI) addressed to a paging-radio network temporary identifier (P-RNTI).

### CROSS-REFERENCE TO RELATED APPLICATION(S) AND CLAIM OF PRIORITY

This application claims priority under 35 U.S.C. § 119 (e) to U.S. Provisional Patent Application No. 63/627,498 filed on Jan. 31, 2024, and U.S. Provisional Patent Application No. 63/669,369 filed on Jul. 10, 2024, and U.S. Provisional Patent Application No. 63/674,587 filed on Jul. 23, 2024. The above-identified provisional patent applications are hereby incorporated by reference in their entirety.

### TECHNICAL FIELD

This disclosure relates generally to wireless networks. More specifically, this disclosure relates to paging by segmenting paging identity.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for paging by segmenting paging identity.

In one embodiment, a user equipment (UE) is provided. The UE includes a processor. The processor is configured to segment a paging identity of the UE into a plurality of paging identity segments including at least a first paging identity segment and a second paging identity segment; determine a paging frame (PF) based on the first paging identity segment; and determine, based on the second paging identity segment, a paging occasion (PO) of the PF. The UE also includes a transceiver operatively coupled to the processor. The transceiver is configured to receive, in one of the determined PO or a paging early indication-occasion (PEI-O), a first physical download control channel (PDCCH) transmission including first downlink control information (DCI) addressed to a paging-radio network temporary identifier (P-RNTI).

In another embodiment, a base station (BS) is provided. The BS includes a processor. The processor is configured to segment a paging identity of a UE into a plurality of paging identity segments including at least a first paging identity segment and a second paging identity segment; determine a PF based on the first paging identity segment; and determine, based on the second paging identity segment, a PO of the PF. The BS also includes a transceiver operatively coupled to the processor. The transceiver is configured to transmit, to the UE, in one of the determined PO or a PEI-O, a first PDCCH transmission including first DCI addressed to a P-RNTI.

In yet another embodiment, a method of operating a UE is provided. The method includes segmenting a paging identity of the UE into a plurality of paging identity segments including at least a first paging identity segment and a second paging identity segment, and determining a PF based on the first paging identity segment. The method also includes determining, based on the second paging identity segment, a PO of the PF, and receiving, in one of the determined PO or a PEI-O, a first PDCCH transmission including first DCI addressed to a P-RNTI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of segmenting a paging identity of a UE according to embodiments of the present disclosure;

FIG. 5 illustrates an example procedure for paging according to embodiments of the present disclosure;

FIG. 6 illustrates another example procedure for paging according to embodiments of the present disclosure;

FIG. 7 illustrates another example procedure for paging according to embodiments of the present disclosure;

FIG. 8 illustrates another example procedure for paging according to embodiments of the present disclosure;

FIG. 9 illustrates another example procedure for paging according to embodiments of the present disclosure;

FIG. 10 illustrates another example procedure for paging according to embodiments of the present disclosure;

FIG. 11 illustrates another example procedure for paging according to embodiments of the present disclosure;

FIG. 12 illustrates another example procedure for paging according to embodiments of the present disclosure;

FIG. 13 illustrates an example method for paging by segmenting paging identity 1300 according to embodiments of the present disclosure;

FIG. 14 illustrates another example method for paging by segmenting paging identity according to embodiments of the present disclosure;

FIG. 15 illustrates an example procedure for barring in wireless communication system according to embodiments of the present disclosure;

FIG. 16 illustrates another example procedure for barring in wireless communication system according to embodiments of the present disclosure;

FIG. 17 illustrates another example procedure for barring in wireless communication system according to embodiments of the present disclosure;

FIG. 18 illustrates another example procedure for barring in wireless communication system according to embodiments of the present disclosure;

FIG. 19 illustrates another example procedure for barring in wireless communication system according to embodiments of the present disclosure; and

FIG. 20 illustrates another example procedure for barring in wireless communication system according to embodiments of the present disclosure.

### DETAILED DESCRIPTION

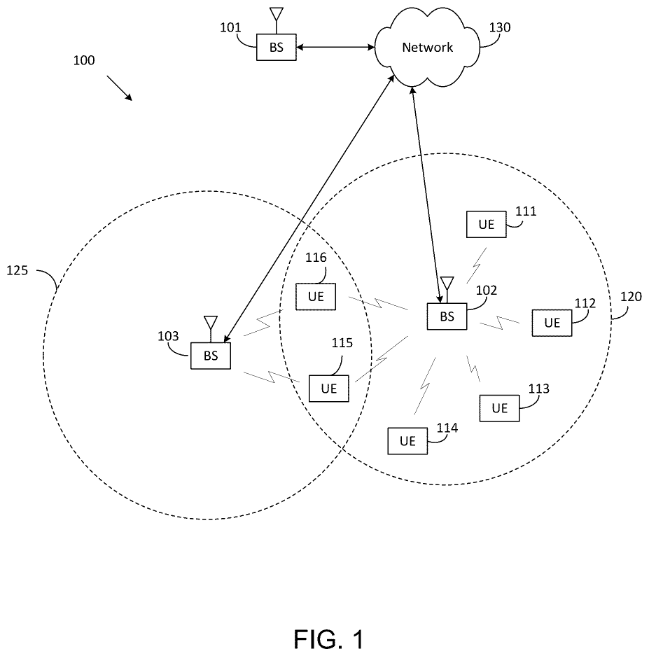

FIGS. 1 through 20, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for paging by segmenting paging identity. In certain embodiments, one or more of the gNBs 101-103 includes circuitry, programing, or a combination thereof, to support paging by segmenting paging identity in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

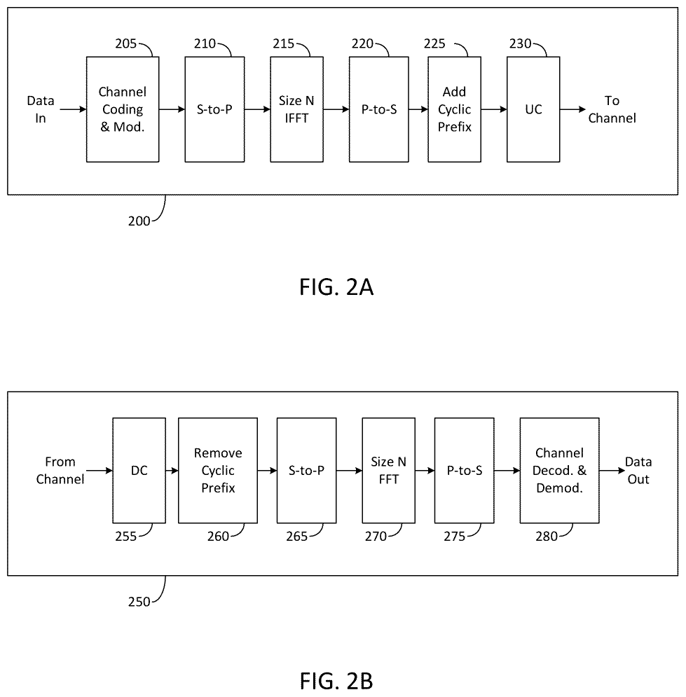

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support paging by segmenting paging identity as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

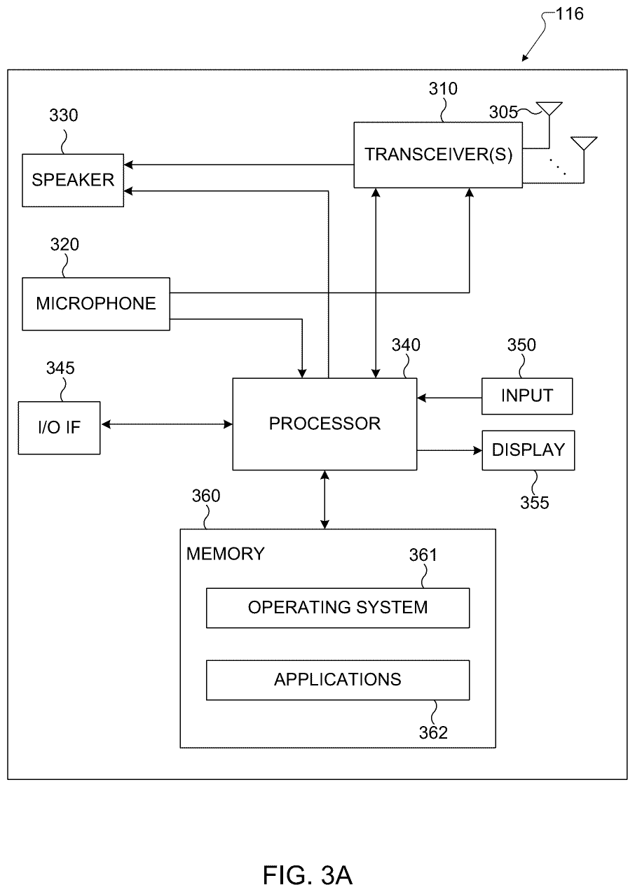

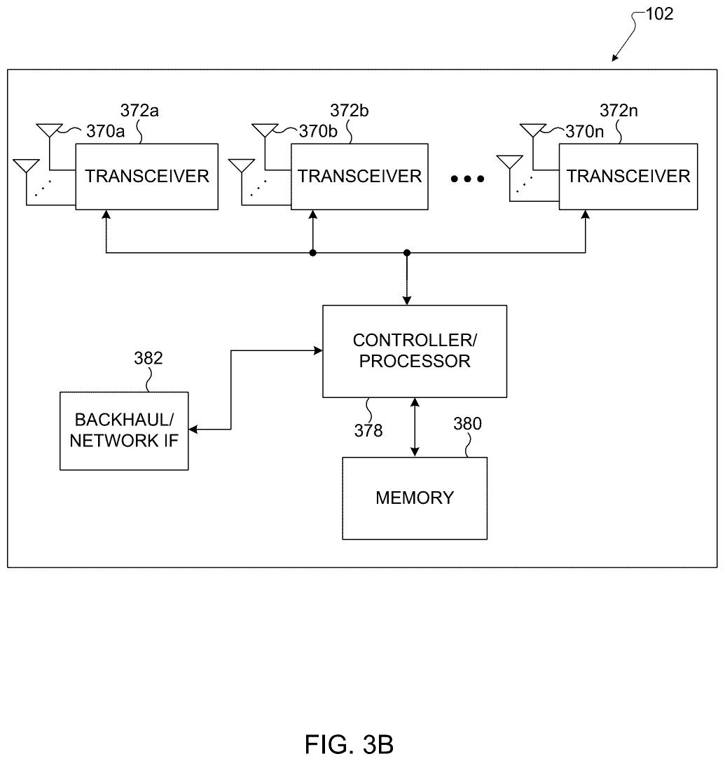

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for paging by segmenting paging identity as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support paging by segmenting paging identity as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G (B5G), 6G) supports not only lower frequency bands but also higher frequency (mmWave, tera hertz) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve the UEs having quite different capabilities depending on the use case and market segment the UE cater service to the end customer. Few example use cases the next generation wireless communication system wireless system is expected to address is enhanced Mobile Broadband (eMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the next generation wireless communication system (e.g., 5G, beyond 5G (B5G), 6G) operating in higher frequency (e.g., mmWave, terahertz) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in the increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using an RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a transmit (TX) beam. Wireless communication system operating at high frequency use a plurality of narrow TX beams to transmit signals in the cell as each narrow TX beam provides coverage to a part of cell. The narrower the TX beam, the higher the antenna gain and hence the larger the propagation distance of a signal transmitted using beamforming. A receiver can also generate a plurality of receive (RX) beam patterns of different directions. Each of these receive patterns can be also referred to as a receive (RX) beam.

The next generation wireless communication system (e.g., 5G, beyond 5G (B5G), 6G), supports standalone modes of operation as well as dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports a Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising of the primary cell (PCell) and optionally one or more secondary cells (SCells). In NR the term Secondary Cell Group (SCG) refers to a group of serving cells associated with the Secondary Node, comprising the Primary SCG Cell (PSCell) and optionally one or more SCells. In NR, PCell refers to a serving cell in the MCG, operating on the primary frequency, in which the UE either performs the initial connection establishment procedure or initiates the connection re-establishment procedure. In NR for a UE configured with CA, an SCell is a cell providing additional radio resources on top of the Special Cell. PSCell refers to a serving cell in the SCG in which the UE performs random access when performing the Reconfiguration with Sync procedure. For Dual Connectivity operation the term Special Cell (SpCell) refers to the PCell of the MCG or the PSCell of the SCG, otherwise the term Special Cell refers to the PCell.

In the next generation wireless communication system (e.g., 5G, beyond 5G (B5G), 6G), a node B (gNB) or base station in cell broadcast Synchronization Signal and PBCH block (SSB) comprises primary and secondary synchronization signals (PSS, SSS) and system information. The system information includes common parameters needed to communicate in a cell. In the next generation wireless communication system (also referred to as next generation radio or NR), System Information (SI) is divided into the master information block (MIB) and a number of system information blocks (SIBs) where: The MIB is transmitted on the broadcast channel (BCH) with a periodicity of 80 ms and repetitions made within 80 ms and the MIB includes parameters that are needed to acquire a SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, SIB1 repetition transmission period is 20 ms. For SSB and CORESET multiplexing pattern 2/3, SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which comprises one or several cells and is identified by systemInformationAreaID. The mapping of SIBs to system information (SI) messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RRCReconfiguration message, (e.g., if the UE has an active BWP with no common search space configured to monitor system information), paging, or upon request from the UE. In an RRC_CONNECTED state, the UE acquires the required SIB(s) only from the PCell. For the PSCell and SCells, the network provides the required SI by dedicated signaling, (i.e., within an RRC Reconfiguration message). Nevertheless, the UE acquires the MIB of the PSCell to get system frame number (SFN) timing of the SCG (which may be different from the MCG). Upon a change of relevant SI for the SCell, the network releases and adds the concerned SCell. For the PSCell, the required SI can be changed with Reconfiguration with Sync.

In the next generation wireless communication system (e.g., 5G, beyond 5G (B5G), 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in an RRC CONNECTED state. Several types of random-access procedure are supported such as contention based random access, contention free random access and each of these can be one of 2 step or 4 step random access.

In the next generation wireless communication system (e.g., 5G, beyond 5G (B5G), 6G), a Physical Downlink Control Channel (PDCCH) is used to schedule DL transmissions on a physical downlink shared channel (PDSCH) and UL transmissions on a physical uplink shared channel (PUSCH), where the Downlink Control Information (DCI) on the PDCCH includes: downlink assignments containing at least modulation and coding format, resource allocation, and hybrid-ARQ information related to a downlink shared channel (DL-SCH); uplink scheduling grants containing at least modulation and coding format, resource allocation, and hybrid-ARQ information related to an uplink shared channel (UL-SCH). In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprise a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mapping is supported in a CORESET. Polar coding is used for the PDCCH. Each resource element group carrying the PDCCH carries its own DMRS. QPSK modulation is used for the PDCCH.

In the next generation wireless communication system (e.g., 5G, beyond 5G (B5G), 6G), a list of search space configurations is signaled by the gNB for each configured BWP of the serving cell, wherein each search configuration is uniquely identified by a search space identifier. Each search space identifier is unique amongst the BWPs of a serving cell. An identifier of the search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

$$( y * ( number of slots in radio frame ) + x - Monitoring - offset - PDCCH - slot ) mod ( Monitoring - periodicity - PDCCH - slot ) = 0.$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. A search space configuration includes the identifier of the CORESET configuration associated with it. A list of COREST configurations are signaled by the gNB for each configured BWP of the serving cell, wherein each coreset configuration is uniquely identified by a CORESET identifier. Each CORESET identifier is unique amongst the BWPs of a serving cell. Note that each radio frame is of 10 ms duration. Each radio frame is identified by a radio frame number or system frame number. Each radio frame comprises several slots, wherein the number of slots in a radio frame and duration of slots depends on sub carrier spacing. The number of slots in a radio frame and duration of slots for each supported SCS is pre-defined in NR. Each CORESET configuration is associated with a list of transmission configuration indicator (TCI) states. One DL RS ID (SSB or CSI RS) is configured per TCI state. The list of TCI states corresponding to a CORESET configuration is signaled by the gNB via RRC signaling. One of the TCI states in the TCI state list is activated and indicated to the UE by the gNB. A TCI state indicates the DL TX beam (DL TX beam is QCLed with SSB/CSI RS of TCI state) used by the gNB for transmission of the PDCCH in the PDCCH monitoring occasions of a search space.

In the next generation wireless communication system (e.g., 5G, beyond 5G (B5G), 6G) bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can only monitor the PDCCH on the one active BWP (i.e., it does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-InactivityTimer, by RRC signaling, or by the MAC entity itself upon initiation of a Random-Access procedure. Upon addition of an SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of a BWP inactivity timer, the UE switches the active DL BWP to the default DL BWP or initial DL BWP (if a default DL BWP is not configured).

In the next generation wireless communication system (e.g., 5G, beyond 5G (B5G), 6G), a UE can be in one of the following RRC states: RRC IDLE, RRC INACTIVE and RRC CONNECTED. Paging allows the network to reach UEs in an RRC_IDLE and in RRC_INACTIVE state through Paging messages, and to notify UEs in an RRC_IDLE, RRC_INACTIVE and RRC_CONNECTED state of a system information change and ETWS (Earthquake and Tsunami Warning System)/CMAS (Commercial Mobile Alert System) indications through Short Messages. Both Paging messages and Short Messages are addressed with P-RNTI on PDCCH, but while the former is sent on the PCCH logical channel (a transport block [TB] carrying a paging message is transmitted over the PDSCH), the latter is sent over the PDCCH directly.

While in an RRC_IDLE state, the UE monitors the paging channels for CN-initiated paging. While in an RRC_INACTIVE state the UE monitors paging channels for RAN-initiated paging and CN-initiated paging. A UE need not monitor paging channels continuously though. Paging discontinuous reception (DRX) is defined where the UE in an RRC_IDLE or RRC_INACTIVE state only monitors paging channels during one Paging Occasion (PO) per DRX cycle.

A PO is a set of PDCCH monitoring occasions and can comprise multiple time slots (e.g., subframe or OFDM symbol) where paging DCI (i.e., PDCCH addressed to a P-RNTI) can be sent. One Paging Frame (PF) is one Radio Frame and may contain one or multiple PO(s) or a starting point of a PO. A PO associated with a PF may start in the PF or after the PF.

In multi-beam operations, the UE assumes that the same paging message and the same Short Message are repeated in all transmitted beams and thus the selection of the beam(s) for the reception of the paging message and Short Message is up to UE implementation. The paging message is the same for both RAN initiated paging and CN initiated paging. The UE initiates an RRC Connection Resume procedure upon receiving RAN initiated paging. If the UE receives a CN initiated paging in an RRC_INACTIVE state, the UE moves to an RRC_IDLE state and informs NAS.

The PF and PO for paging are determined (by the UE and base station e.g., gNB) by the following formulae:
SFN for the PF is determined by:

$$( S F N + PF\_offset ) mod T = ( T div N ) * ( UE\_ID mod N )$$

Index (i_s), indicating the index of the PO is determined by:

$$i\_s = floor ( UE\_ID / N ) mod Ns$$

The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI.

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the Kth transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

The following parameters are used for the calculation of PF and i_s above:
T: DRX cycle of the UE.
N: number of total paging frames in T; N is one of T, T/2, T/4, T/8, T/16
Ns: number of paging occasions for a PF; NS is one of 1, 2, 4
PF_offset: offset used for PF determination
UE_ID:
If the UE operates in eDRX:
   5G-S-TMSI mod 4096
otherwise:
   5G-S-TMSI mod 1024

Parameters Ns, nAndPagingFrameOffset, nrofPDCCH-MonitoringOccasionPer SSB-InPO, and the length of default DRX Cycle are signaled in SIB1. The values of N and PF_offset are derived from the parameter nAndPagingFrameOffset. The parameter firstPDCCH-MonitoringOccasionOfPO is signaled in SIB1 for paging in the BWP configured by initialDownlinkBWP. For paging in a DL BWP other than the BWP configured by initialDownlinkBWP, the parameter first-PDCCH-MonitoringOccasionOfPO is signaled in the corresponding BWP configuration. If the UE has no 5G-S-TMSI, for instance when the UE has not yet registered onto the network, the UE shall use as default identity UE_ID=0 in the PF and i_s formulas above.

In order to reduce UE power consumption due to false paging alarms, the group of UEs monitoring the same PO can be further divided into multiple subgroups. With subgrouping, a UE shall monitor the PDCCH in its PO for paging if the subgroup to which the UE belongs is paged as indicated via associated Paging Early Indication (PEI). If a UE cannot find its subgroup ID with the PEI configurations in a cell or if the UE is unable to monitor the associated PEI occasion (PEI-O) corresponding to its PO, it shall monitor the paging in its PO.

Paging with CN assigned subgrouping is used in the cell which supports CN assigned subgrouping. A UE supporting CN assigned subgrouping in an RRC_IDLE or RRC_INACTIVE state can be assigned a subgroup ID (between 0 to 7) by the AMF through NAS signaling.

If the UE is not configured with a CN assigned subgroup ID, or if the UE configured with a CN assigned subgroup ID is in a cell supporting only UE_ID based subgrouping, the subgroup ID of the UE is determined by the formula below:

SubgroupID=(floor(UE_ID/(N*Ns)) mod subgroupsNumForUEID)+(subgroupsNumPerPO−subgroupsNumForUEID),

where:
N: number of total paging frames in T, which is the DRX cycle of RRC_IDLE state
Ns: number of paging occasions for a PF
UE_ID: 5G-S-TMSI mod X, where X is 32768, if eDRX is applied; otherwise, X is 8192 subgroupsNumForUEID: number of subgroups for UE_ID based subgrouping in a PO, which is broadcasted in system information

The UE monitors one PEI occasion (PEI-O) per DRX cycle. A PEI-O is a set of PDCCH monitoring occasions (MOs) and can comprise multiple time slots (e.g., subframes or OFDM symbols) where a PEI can be sent. In multi-beam operations, the UE assumes that the same PEI is repeated in all transmitted beams and thus the selection of the beam(s) for the reception of the PEI is up to UE implementation. The time location of a PEI-O for the UE's PO is determined by a reference point and an offset:
The reference point is the start of a reference frame determined by a frame-level offset from the start of the first PF of the PF(s) associated with the PEI-O, provided by pei-FrameOffset in SIB1; The first PF of the PFs associated with the PEI-O is provided by (SFN for PF)—floor (i_{PO}/Ns)*TIN; where i_{PO}=((UE_IDmodN)·N_{S}+i_s)modN_{PO}^{PEI} is a paging occasion index, N_{PO}^{PEI}, is signaled by po-NumPerPEI.
The offset is a symbol-level offset from the reference point to the start of the first PDCCH MO of this PEI-O, provided by firstPDCCH-MonitoringOccasionOfPEI-O in SIB1.

A UE receives a PDCCH addressed to a P-RNTI in a paging occasion of a Paging frame. The UE receives the paging message in a transport block (TB) scheduled by DCI of the PDCCH. The paging message includes the paging identity of one or more UEs. A paging message with full paging identity (32 bits) limits the number of UEs that can be paged. Various embodiments of the present disclosure provide paging by segmenting paging identity to overcome this limitation.

Cell barring is supported in the next generation wireless communication system (e.g., 5G, beyond 5G (B5G), 6G). There are various types of cell barring indications supported in the next generation wireless communication system.

A Cellbarred bit is included in the MIB. The Cellbarred bit It is set to either ‘barred’ or ‘notbarred’. If the Cellbarred bit is set to barred, the UE bars the cell (i.e., does not camp on the cell) for a pre-defined time. This field is ignored by IAB-MT and NCR-MT. This field is ignored for connectivity to NTN or ATG.

Several types of barring indication(s) are included in SIB 1:
cellBarred-eRedCap1Rx may be included in SIB 1. It is set to either ‘barred’ or ‘notbarred’. This field is applicable to reduced capability UEs (also referred to as redCap UEs) with 1 receiver chain capability. The value barred means that the cell is barred for an eRedCap UE with 1 Rx branch. This field is ignored by non-eRedCap UEs. An eRedCap UE with 1 Rx branch will check this field if a Cellbarred bit included in the MIB is set to ‘notbarred’.
cellBarred-eRedCap2Rx may be included in SIB 1. It is set to either ‘barred’ or ‘notbarred’. This field is applicable to reduced capability UEs (also referred to as redCap UEs) with 2 receiver chains capability. The value barred means that the cell is barred for an eRedCap UE with 2 Rx branches. This field is ignored by non-eRedCap UEs. An eRedCap UE with 2 Rx branches will check this field if a Cellbarred bit included in the MIB is set to ‘notbarred’.
cellBarredRedCap1Rx may be included in SIB 1. It is set to either ‘barred’ or ‘notbarred’. The value barred means that the cell is barred for a RedCap UE with 1 Rx branch. This field is ignored by non-RedCap UEs. A RedCap UE with 1 Rx branch will check this field if a Cellbarred bit included in the MIB is set to ‘notbarred’.
cellBarredRedCap2Rx may be included in SIB 1. It is set to either ‘barred’ or ‘notbarred’. The value barred means that the cell is barred for an RedCap UE with 2 Rx branches. This field is ignored by non-RedCap UEs. An eRedCap UE with 2 Rx branches will check this field if a Cellbarred bit included in the MIB is set to ‘notbarred’.
cellBarredNTN may be included in SIB 1. It is set to either ‘barred’ or ‘notbarred’. This field is applicable to a UE supporting NTN. The value barred means that the cell is barred for connectivity to NTN. The value notBarred means that the cell is allowed for connectivity to NTN. If not present, the UE considers the cell is not allowed for connectivity to NTN. This field is only applicable to NTN-capable UEs. NTN-capable UEs will check this field irrespective of the setting of a Cellbarred bit in the MIB.
cellBarredNES may be included in SIB 1. It is set to ‘notbarred’. The presence of this field indicates that the cell is allowed for UEs supporting NES cell DTX/DRX. An NES UE will check this field if a Cellbarred bit included in the MIB is set to ‘notbarred’.
cellBaredATG may be included in SIB 1. It is set to either ‘barred’ or ‘notbarred’. This field is applicable to a UE supporting ATG. The value barred means that the cell is barred for connectivity to ATG. The value notBarred means that the cell is allowed for connectivity to ATG. If not present, the UE considers the cell is not allowed for connectivity to ATG. An ATG-capable UEs will check this field irrespective of setting of a Cellbarred bit in the MIB.

In order to decide whether to camp or not camp on a cell, or bar a cell or not, a UE needs to receive and decode both the MIB and SIB1. For UEs supporting a specific network type/capability, the determination to bar cell or not requires more effort (i.e., the UE needs to receive and decode SIB1 in addition to the MIB) and also leads to more latency/energy consumption during cell selection/reselection. Various embodiments of the present disclosure provide for cell barring that overcomes these limitations.

As noted above, various embodiments of the present disclosure provide paging by segmenting paging identity.

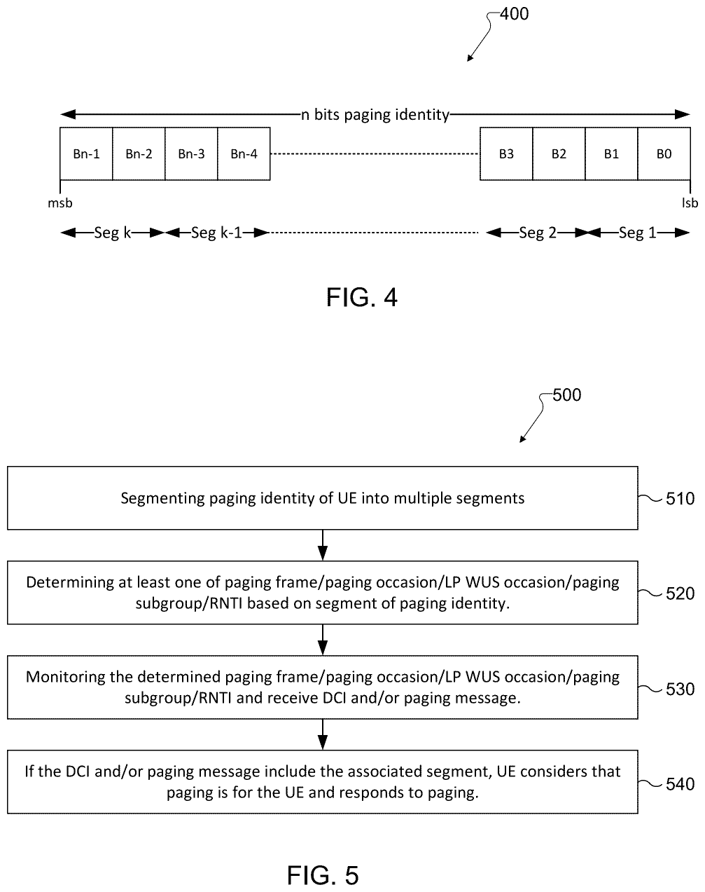

FIG. 4 illustrates an example 400 of segmenting a paging identity of a UE according to embodiments of the present disclosure. The embodiment of segmenting a paging identity of a UE of FIG. 4 is for illustration only. Different embodiments of segmenting a paging identity of a UE could be used without departing from the scope of this disclosure.

In the example of FIG. 4, ‘n’ bits of a paging identity (e.g., a 5G-S-TMSI or S-TMSI or I-RNTI, etc.) of a UE (such as UE 116 of FIG. 1) is divided/segmented into multiple (k, k>1) segments where each segment comprises a plurality of bits of the paging identity of UE. The size (i.e., number of bits) of each segment can be the same or different. Each segment includes consecutive bits of the paging identity of the UE. For example, the paging identity of the UE can be 32 bits and divided into four segments, where segment 1 includes b0 to b7, segment 2 includes b8 to b15, segment 3 includes b16 to b23, segment 4 includes b24 to b31.

In some embodiments, each segment of the paging identity can be defined by the starting bit number, ending bit number/number of bits of the segment, where the starting bit number, ending bit number/number of bits of the segment can be pre-defined or signaled by a gNB (such as BS 102 of FIG. 1).

In some embodiments, each segment of the paging identity can be determined by a mathematical operation such as a modulo operation and/or a division operation. For example, assuming the paging identity of the UE is 16 bits and divided into three segments, segment 1 of size 8 bits (b0 to b7) can be determined by the paging identity of UE mod 256, segment 2 of size 4 bits (b8 to b11) can be determined by ‘(the paging identity of UE div 256) mod 16, segment 3 of size 4 bits (b12 to b15) can be determined by’ [the paging identity of UE div (256*16)] mod 16.

Although FIG. 4 illustrates an example 400 of segmenting a paging identity of a UE, various changes may be made to FIG. 4. For example, the number of bits in each segment could be changed, the correspondence between the segments and the most significant bit (msb)/least significant bit (lsb) could be changed, etc. according to particular needs.

FIG. 5 illustrates an example procedure for paging 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for paging could be used without departing from the scope of this disclosure.

In the example of FIG. 5, procedure 500 begins at step 510. At step 510, the paging identity of UE (such as UE 116 of FIG. 1) is divided into multiple segments. In some embodiments, the paging identity of the UE is divided into multiple segments by the UE. In some embodiments, the paging identity of the UE is divided into multiple segments by a gNB (such as BS 102 of FIG. 1).

At step 520, the UE determines at least one of a paging frame/paging occasion/PEI occasion/LP WUS occasion/paging subgroup/RNTI based on a segment of the paging identity.

At step 530, the UE monitors the determined paging frame and/or paging occasion and/or PEI occasion and/or LP WUS occasion and/or paging subgroup and/or RNTI and receives DCI and/or a paging message.

At step 540, in some embodiments, if the received DCI includes the segment of UE's paging identity (i.e., the segment associated with DCI or the segment of the paging identity which is included in a DCI for paging), the UE considers that the paging is for the UE and responds to the paging.

Alternately at step 540, in some embodiments, if the received paging message includes the segment of the UE's paging identity (i.e., the segment associated with the paging message or the segment of the paging identity which is included in the paging message for paging), the UE considers that the paging is for the UE and responds to the paging.

Alternately at step 540, in some embodiments, if the received DCI includes the segment of UE's paging identity (i.e., the segment associated with DCI or the segment of the paging identity which is included in the DCI for paging) and if the received paging message includes the segment of the UE's paging identity (i.e., the segment associated with the paging message or the segment of the paging identity which is included in the paging message for paging), the UE considers that the paging is for the UE and responds to the paging.

In some embodiments, there can be several paging frames for paging and a segment of the paging identity is used to determine the paging frame for paging. The segment to be used for determining the paging frame for paging can be configured/signaled by the network or can be pre-defined. The size of the segment to be used for determining the paging frame for paging can be configured/signaled by network or can be pre-defined or can be determined based on the number of paging frames.

In some embodiments, there can be several paging occasions for paging and a segment of the paging identity is used to determine the paging occasion for paging. The segment to be used for determining the paging occasion for paging can be configured/signaled by the network or can be pre-defined. The size of the segment to be used for determining the paging occasion for paging can be configured/signaled by the network or can be pre-defined or can be determined based on the number of paging occasions.

In some embodiments, there can be several low power wakeup signal occasions (LPWUS-Os) for a low power wakeup signal (LPWUS) and a segment of the paging identity is used to determine the LPWUS-O. The segment to be used for determining the LPWUS-O for the paging can be configured/signaled by the network or can be pre-defined. The size of the segment to be used for determining the LPWUS-O for paging can be configured/signaled by the network or can be pre-defined or can be determined based on the number of LPWUS-Os.

In some embodiments, there can be several paging subgroups for paging and a segment of the paging identity is used to determine the UE's paging subgroup. The segment to be used for determining the UE's paging subgroup can be configured/signaled by the network or can be pre-defined. The size of the segment to be used for determining the UE's paging subgroup for paging can be configured/signaled by the network or can be pre-defined or can be determined based on the number of paging subgroups.

In some embodiments, there can be several LPWUS subgroups, and a segment of the paging identity is used to determine the UE's LPWUS subgroup. The segment to be used for determining the UE's LPWUS subgroup can be configured/signaled by the network or can be pre-defined. The size of the segment to be used for determining the UE's LPWUS subgroup for paging can be configured/signaled by the network or can be pre-defined or can be determined based on the number of LPWUS subgroups.

In some embodiments, there can be several RNTIs for paging and a segment of the paging identity is used to determine the RNTI for paging. The segment to be used for determining the RNTI for paging can be configured/signaled by the network or can be pre-defined. The size of the segment to be used for determining the RNTI for paging can be configured/signaled by the network or can be pre-defined or can be determined based on the number of RNTIs for paging.

In some embodiments, a segment can be included in the DCI of the PDCCH for paging. The segment to be included in the DCI of the PDCCH for paging can be configured/signaled by the network or can be pre-defined. The size of segment to be included in the DCI of the PDCCH for paging can be configured/signaled by the network or can be pre-defined.

In some embodiments, a segment can be included in the paging message for paging. The segment to be included in the paging message can be configured/signaled by the network or can be pre-defined. The size of the segment to be included in the paging message can be configured/signaled by the network or can be pre-defined.

Although FIG. 5 illustrates one example procedure for paging 500, various changes may be made to FIG. 5. For example, while shown as a series of steps, various steps in FIG. 5 could overlap, occur in parallel, occur in a different order, occur any number of times, be omitted, or replaced by other steps.

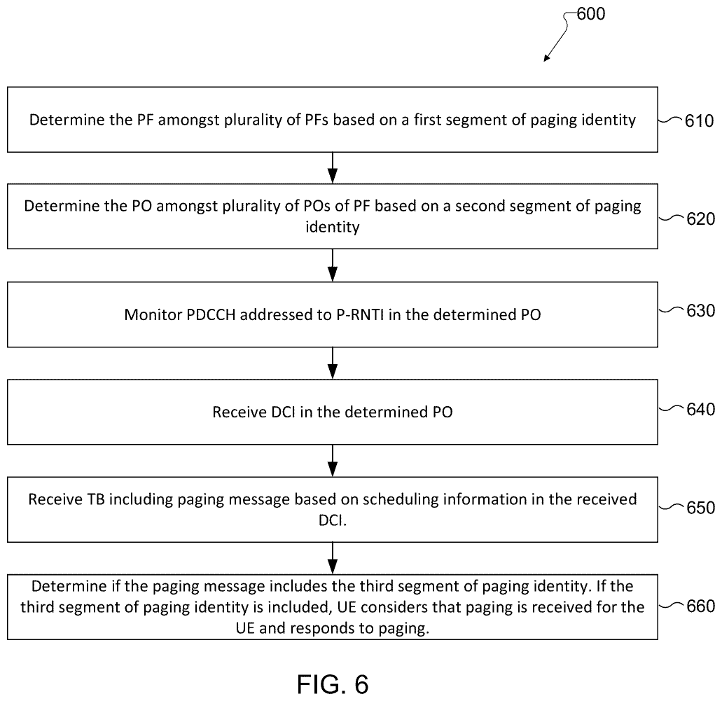

FIG. 6 illustrates another example procedure for paging 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for paging could be used without departing from the scope of this disclosure.

In the example of FIG. 6, the paging identity of a UE (such as UE 116 of FIG. 1) may be divided into at least three segments. In some embodiments, the paging identity of the UE is divided into the at least three segments by the UE. In some embodiments, the paging identity of the UE is divided into the at least three segments by a gNB (such as BS 102 of FIG. 1).

Procedure 600 begins at step 610. At step 610, the UE determines a PF amongst plurality of PFs based on a first segment of UE's paging identity. In some embodiments, if the number of paging frames is N, the number of bits (k1) in the first segment can be log2(N). In some embodiments, the number of bits (k1) in the first segment can be pre-defined or configured/signaled by the gNB. In some embodiments, the starting bit number, ending bit number/number of bits of the first segment can be pre-defined or configured/signaled by the gNB.

In some embodiments, the first segment can be k1 least significant bits (lsbs) of the UE's paging identity. In some embodiments, the first segment can be k1 bits (lsb to most significant bit [msb]) after the second segment or third segment. In some embodiments, the first segment is the UE's paging identity mod N, or the first segment is (the UE's paging identity/N1) mod N or the first segment is floor [(the UE's paging identity/N1) mod N].

At step 620, the UE determines a PO amongst a plurality of POs of a PF based on a second segment of the UE's paging identity. In some embodiments, if the number of POs is N1, the number of bits (k2) in second segment can be log2(N1). In some embodiments, the number of bits (k2) in the second segment can be pre-defined or configured/signaled by the gNB. In some embodiments, the starting bit number, ending bit number/number of bits of the second segment can be pre-defined or configured/signaled by the gNB.

In some embodiments, the second segment can be k2 lsbs of the UE's paging identity. In some embodiments, the second segment can be k2 bits (lsb to msb) after the first segment or third segment. In some embodiments, the second segment is the UE's paging identity mod N1, or the second segment is (the UE's paging identity/N) mod N1 or the second segment is floor [(the UE's paging identity/N) mod N1].

At step 630, the UE monitors PDCCH addressed to the P-RNTI in the determined PO.

At step 640, the UE receives the PDCCH addressed to the P-RNTI (i.e., DCI) in the determined PO.

At step 650, the UE receives a TB including a paging message based on scheduling information in the received DCI.

At step 660, the UE determines if the paging message includes the third segment of the UE's paging identity. If the third segment of the UE's paging identity is included in the paging message (i.e., the segment in the paging message matches the corresponding segment of the UE's paging identity), the UE considers that the paging is received for the UE and responds to the paging. In some embodiments, the number of bits in the third segment can be ‘number of bits in the UE's paging identity-(number of bits of the first segment+number of bits of second segment)’. In some embodiments, the number of bits in the third segment can be pre-defined or configured/signaled by the gNB. In some embodiments, the starting bit number, ending bit number/number of bits of the third segment can be pre-defined or configured/signaled by the gNB.

Although FIG. 6 illustrates one example procedure for paging 600, various changes may be made to FIG. 6. For example, while shown as a series of steps, various steps in FIG. 6 could overlap, occur in parallel, occur in a different order, occur any number of times, be omitted, or replaced by other steps.

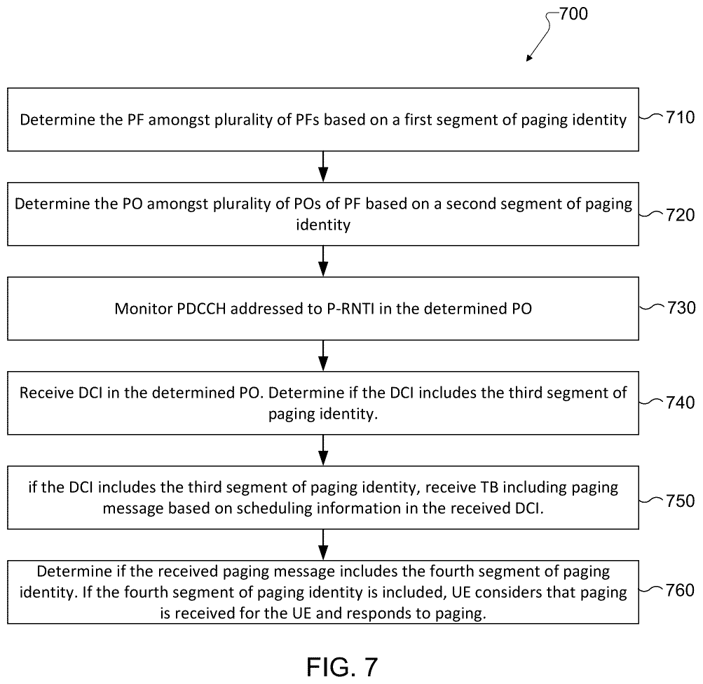

FIG. 7 illustrates another example procedure for paging 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for paging could be used without departing from the scope of this disclosure.

In the example of FIG. 7, the paging identity of a UE (such as UE 116 of FIG. 1) may be divided into at least four segments. In some embodiments, the paging identity of the UE is divided into the at least four segments by the UE. In some embodiments, the paging identity of the UE is divided into the at least four segments by a gNB (such as BS 102 of FIG. 1).

Procedure 700 begins at step 710. At step 710, the UE determines a PF amongst a plurality of PFs based on a first segment of the UE's paging identity. In some embodiments, if the number of the paging frame is N, the number of bits (k1) in the first segment can be log2(N). In some embodiments, the number of bits (k1) in the first segment can be pre-defined or configured/signaled by the gNB. In some embodiments, the starting bit number, ending bit number/number of bits of first segment can be pre-defined or configured/signaled by the gNB.

In some embodiments, the first segment can be k1 lsbs of the UE's paging identity. In some embodiments, the first segment can be k1 bits (lsb to msb) following the second segment or third segment. In some embodiments, the first segment is the UE's paging identity mod N, or the first segment is (the UE's paging identity/N1) mod N or the first segment is floor [(the UE's paging identity/N1) mod N].

At step 720, the UE determines a PO amongst a plurality of POs of the PF based on a second segment of the UE's paging identity. In some embodiments, if the number of POs is N1, the number of bits (k2) in the second segment can be log2(N1). In some embodiments, the number of bits (k2) in the second segment can be pre-defined or configured/signaled by the gNB. In some embodiments, the starting bit number, ending bit number/number of bits of the second segment can be pre-defined or configured/signaled by gNB.

In some embodiments, the second segment can be k2 lsbs of the UE's paging identity. In some embodiments, the second segment can be k2 bits (lsb to msb) following the first segment or third segment. In some embodiments, the second segment is the UE's paging identity mod N1, or the second segment is (the UE's paging identity/N) mod N1 or the second segment is floor [(the UE's paging identity/N) mod N1].

At step 730, the UE monitors the PDCCH addressed to the P-RNTI in the determined PO.

At step 740, the UE receives the PDCCH addressed to the P-RNTI (i.e., DCI) in the determined PO, and the UE determines if the DCI includes the third segment of UE's paging identity.

At step 750, if the DCI includes the third segment of the UE's paging identity (i.e., the segment in the DCI matches the corresponding segment of the UE's paging identity), the UE receives a TB including a paging message based on the scheduling information in the received DCI. In some embodiments, the number of bits in the third segment can be pre-defined or configured/signaled by the gNB. In some embodiments, the starting bit number, ending bit number/number of bits of third segment can be pre-defined or configured/signaled by the gNB.

At step 760, the UE determines if the paging message includes the fourth segment of the UE's paging identity. If the fourth segment of the UE's paging identity is included in the paging message (i.e., the segment in the paging message matches the corresponding segment of the UE's paging identity), the UE considers that paging is received for the UE and responds to the paging. In some embodiments, the number of bits in fourth segment can be ‘number of bits in the UE's paging identity-(number of bits of first segment+number of bits of second segment+number of bits of third segment)’. In some embodiments, the number of bits in the fourth segment can be pre-defined or configured/signaled by the gNB. In some embodiments, the starting bit number, ending bit number/number of bits of the fourth segment can be pre-defined or configured/signaled by the gNB.

Although FIG. 7 illustrates one example procedure for paging 700, various changes may be made to FIG. 7. For example, while shown as a series of steps, various steps in FIG. 7 could overlap, occur in parallel, occur in a different order, occur any number of times, be omitted, or replaced by other steps.

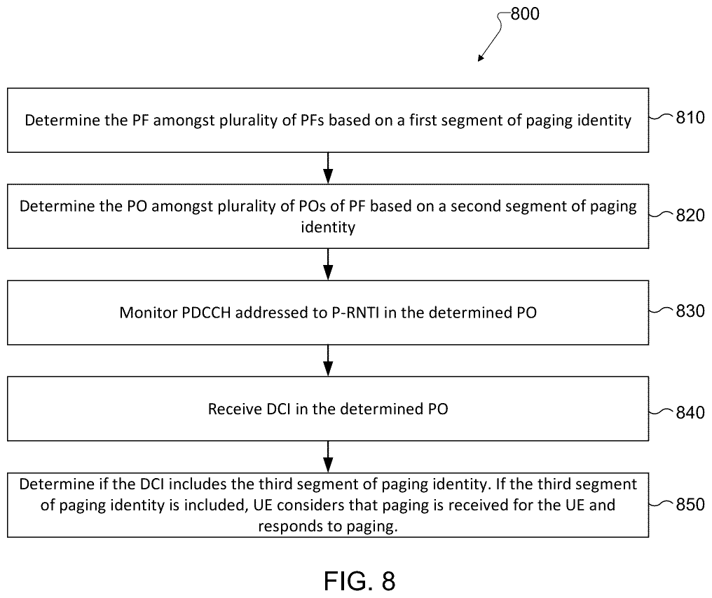

FIG. 8 illustrates another example procedure for paging 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for paging could be used without departing from the scope of this disclosure.

In the example of FIG. 8, the paging identity of a UE (such as UE 116 of FIG. 1) may be divided into at least three segments. In some embodiments, the paging identity of the UE is divided into the at least three segments by the UE. In some embodiments, the paging identity of the UE is divided into the at least three segments by a gNB (such as BS 102 of FIG. 1).

Procedure 800 begins at step 810. At step 810, the UE determines a PF amongst a plurality of PFs based on a first segment of the UE's paging identity. In some embodiments, if the number of the paging frame is N, the number of bits in the first segment can be log2(N). In some embodiments, the number of bits in the first segment can be pre-defined or configured/signaled by the gNB. In some embodiments, the starting bit number, ending bit number/number of bits of the first segment can be pre-defined or configured/signaled by the gNB.

In some embodiments, the first segment can be k1 lsbs of the UE's paging identity. In some embodiments, the first segment can be k1 bits (lsb to msb) following the second segment or third segment. In some embodiments, the first segment is the UE's paging identity mod N, or the first segment is (the UE's paging identity/N1) mod N or the first segment is floor [(the UE's paging identity/N1) mod N].

At step 820, the UE determines a PO amongst a plurality of POs of the PF based on a second segment of the UE's paging identity. In some embodiments, if the number of POs is N1, the number of bits in the second segment can be log2(N1). In some embodiments, the number of bits (k2) in the second segment can be pre-defined or configured/signaled by the gNB. In some embodiments, the starting bit number, ending bit number/number of bits of the second segment can be pre-defined or configured/signaled by the gNB.

In some embodiments, the second segment can be k2 lsbs of the UE's paging identity. In some embodiments, the second segment can be k2 bits (lsb to msb) following the first segment or third segment. In some embodiments, the second segment is the UE's paging identity mod N1, or the second segment is (the UE's paging identity/N) mod N1 or the second segment is floor [(the UE's paging identity/N) mod N1].

At step 830, the UE monitors the PDCCH addressed to the P-RNTI in the determined PO.

At step 840, the UE receives the PDCCH addressed to the P-RNTI (i.e., DCI) in the determined PO.

At step 850, the UE determines if the DCI includes the third segment of UE's paging identity. If the DCI includes the third segment of the UE's paging identity (i.e., the segment in the DCI matches the corresponding segment of the UE's paging identity), the UE considers that paging is received for the UE and responds to the paging. In some embodiments, the number of bits in the third segment can be ‘number of bits in the UE's paging identity-(number of bits of first segment+number of bits of second segment)’. In some embodiments, the number of bits in third segment can be pre-defined or configured/signaled by the gNB. In some embodiments, the starting bit number, ending bit number/number of bits of third segment can be pre-defined or configured/signaled by the gNB.

Although FIG. 8 illustrates one example procedure for paging 800, various changes may be made to FIG. 8. For example, while shown as a series of steps, various steps in FIG. 8 could overlap, occur in parallel, occur in a different order, occur any number of times, be omitted, or replaced by other steps.

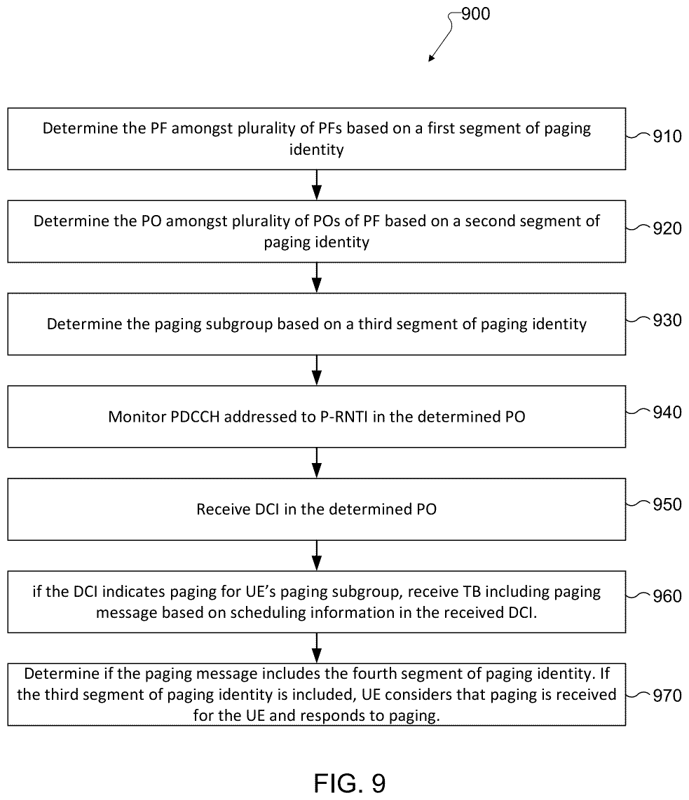

FIG. 9 illustrates another example procedure for paging 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for paging could be used without departing from the scope of this disclosure.

In the example of FIG. 9, the paging identity of a UE (such as UE 116 of FIG. 1) may be divided into at least four segments. In some embodiments, the paging identity of the UE is divided into the at least four segments by the UE. In some embodiments, the paging identity of the UE is divided into the at least four segments by a gNB (such as BS 102 of FIG. 1).

Procedure 900 begins at step 910. At step 910, the UE determines a PF amongst a plurality of PFs based on a first segment of the UE's paging identity. In some embodiments, if the number of the paging frame is N, the number of bits (k1) in the first segment can be log2(N). In some embodiments, the number of bits (k1) in the first segment can be pre-defined or configured/signaled by the gNB. In some embodiments, the starting bit number, ending bit number/number of bits of first segment can be pre-defined or configured/signaled by the gNB.

In some embodiments, the first segment can be k1 lsbs of the UE's paging identity. In some embodiments, the first segment can be k1 bits (lsb to msb) following the second segment or third segment. In some embodiments, the first segment is the UE's paging identity mod N, or the first segment is (the UE's paging identity/N1) mod N or the first segment is floor [(the UE's paging identity/N1) mod N].

As step 920, the UE determines a PO amongst a plurality of POs of the PF based on a second segment of the UE's paging identity. In some embodiments, if the number of POs is N1, the number of bits (k2) in second segment can be log2(N1). In some embodiments, the number of bits (k2) in the second segment can be pre-defined or configured/signaled by the gNB. In some embodiments, the starting bit number, ending bit number/number of bits of the second segment can be pre-defined or configured/signaled by the gNB.

In some embodiments, the second segment can be k2 lsbs of the UE's paging identity. In some embodiments, the second segment can be k2 bits (lsb to msb) following the first segment or third segment. In some embodiments, the second segment is the UE's paging identity mod N1, or the second segment is (the UE's paging identity/N) mod N1 or the second segment is floor ([the UE's paging identity/N] mod N1).

At step 930, the UE determines a paging subgroup based on a third segment of the paging identity. In some embodiments, if the number of paging subgroups is N2, the number of bits (k3) in the third segment can be log2(N2). In some embodiments, the number of bits (k3) in the third segment can be pre-defined or configured/signaled by the gNB. In some embodiments, the starting bit number, ending bit number/number of bits of third segment can be pre-defined or configured/signaled by the gNB.

In some embodiments, the third segment, can be k3 lsbs of UE's paging identity. In some embodiments, the third segment can be k3 bits (lsb to msb) following the first segment or second segment. In some embodiments, the third segment is the UE's paging identity mod N2 or the third segment is (the UE's paging identity/N) mod N2 or the third segment is floor [(the UE's paging identity/N) mod N2] or the third segment is (the UE's paging identity/N1) mod N2 or the third segment is floor [(UE's paging identity/N1) mod N2] or the third segment is (the UE's paging identity/[N*N1]) mod N2 or the third segment is floor {[UE's paging identity/(N*N1)] mod N2}.

At step 940, the UE monitors the PDCCH addressed to the P-RNTI in the determined PO.

At step 950, the UE receives the PDCCH addressed to the P-RNTI (i.e., DCI) in the determined PO, and the UE determines if the DCI indicates paging for the UE's paging subgroup.

At step 960, if the DCI indicates paging for the UE's paging subgroup, the UE receives a TB including a paging message based on the scheduling information in the received DCI.

At step 970, the UE determines if the paging message includes the fourth segment of the UE's paging identity. If the fourth segment of UE's paging identity is included in the paging message (i.e., the segment in paging message matches the corresponding segment of the UE's paging identity), the UE considers that paging is received for the UE and responds to the paging. In some embodiments, the number of bits in fourth segment can be ‘number of bits in the UE's paging identity-(number of bits of first segment+number of bits of second segment+number of bits of third segment)’. In some embodiments, the number of bits in the fourth segment can be pre-defined or configured/signaled by the gNB. In some embodiments, the starting bit number, ending bit number/number of bits of the fourth segment can be pre-defined or configured/signaled by the gNB.

Although FIG. 9 illustrates one example procedure for paging 900, various changes may be made to FIG. 9. For example, while shown as a series of steps, various steps in FIG. 9 could overlap, occur in parallel, occur in a different order, occur any number of times, be omitted, or replaced by other steps.

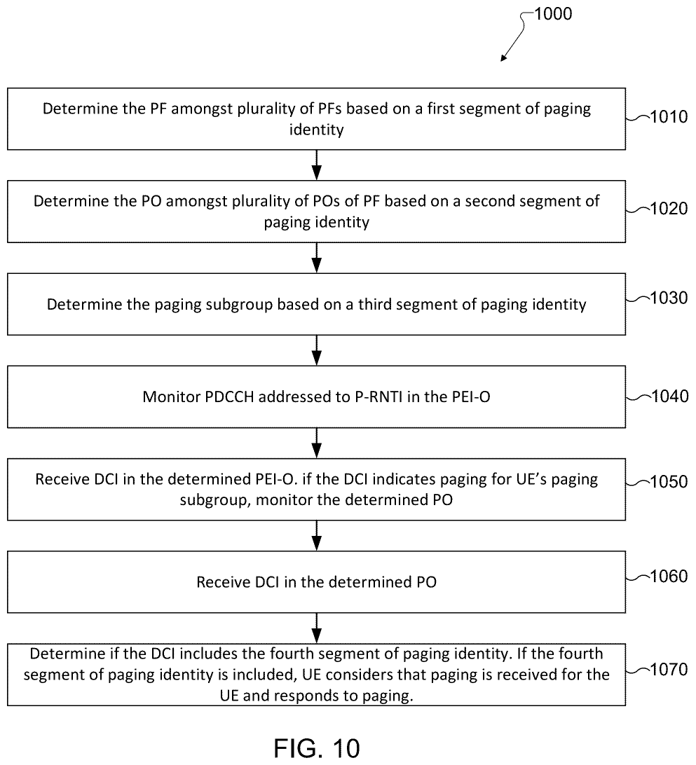

FIG. 10 illustrates another example procedure for paging 1000 according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for paging could be used without departing from the scope of this disclosure.

In the example of FIG. 10, the paging identity of a UE (such as UE 116 of FIG. 1) may be divided into at least four segments. In some embodiments, the paging identity of the UE is divided into the at least four segments by the UE. In some embodiments, the paging identity of the UE is divided into the at least four segments by a gNB (such as BS 102 of FIG. 1).

Procedure 1000 begins at step 1010. At step 1010, the UE determines a PF amongst a plurality of PFs based on a first segment of the UE's paging identity. In some embodiments, if the number of the paging frame is N, the number of bits (k1) in the first segment can be log2(N). In some embodiments, the number of bits (k1) in the first segment can be pre-defined or configured/signaled by the gNB. In some embodiments, the starting bit number, ending bit number/number of bits of first segment can be pre-defined or configured/signaled by the gNB.

In some embodiments, the first segment can be k1 lsbs of the UE's paging identity. In some embodiments, the first segment can be k1 bits (lsb to msb) following the second segment or third segment. In some embodiments, the first segment is the UE's paging identity mod N, or the first segment is (the UE's paging identity/N1) mod N or the first segment is floor [(the UE's paging identity/N1) mod N].

At step 1020, the UE determines a PO amongst a plurality of POs of the PF based on a second segment of the UE's paging identity. In some embodiments, if the number of POs is N1, the number of bits (k2) in the second segment can be log2(N1). In some embodiments, the number of bits (k2) in the second segment can be pre-defined or configured/signaled by the gNB. In some embodiments, the starting bit number, ending bit number/number of bits of the second segment can be pre-defined or configured/signaled by the gNB.

In some embodiments, the second segment, can be k2 lsbs of the UE's paging identity. In some embodiments, the second segment can be k2 bits (lsb to msb) following the first segment or third segment. In some embodiments, the second segment is the UE's paging identity mod N1, or the second segment is (the UE's paging identity/N) mod N1 or the second segment is floor [(the UE's paging identity/N) mod N1].

At step 1030, the UE determines a paging subgroup based on a third segment of the paging identity. In some embodiments, if the number of paging subgroups is N2, the number of bits (k3) in the third segment can be log2(N2). In some embodiments, the number of bits (k3) in the third segment can be pre-defined or configured/signaled by the gNB. In some embodiments, the starting bit number, ending bit number/number of bits of the third segment can be pre-defined or configured/signaled by the gNB.

In some embodiments, the third segment can be k3 lsbs of the UE's paging identity. In some embodiments, the third segment can be k3 bits (lsb to msb) following the first segment or second segment. In some embodiments, the third segment is the UE's paging identity mod N2 or the third segment is (the UE's paging identity/N) mod N2 or the third segment is floor [(the UE's paging identity/N) mod N2] or the third segment is (the UE's paging identity/N1) mod N2 or the third segment is floor [(the UE's paging identity/N1) mod N2] or the third segment is [the UE's paging identity/(N*N1)] mod N2 or the third segment is floor {[the UE's paging identity/(N*N1)] mod N2}.

At step 1040, in some embodiments, the UE monitors the PDCCH addressed to the P-RNTI in the PEI-O.

Alternately at step 1040, in some embodiments, the UE monitors an LPWUS-O for an LPWUS.

At step 1050, in some embodiments, the UE receives the PDCCH addressed to the P-RNTI (i.e., DCI) in the determined PEI-O, and the UE determines if the DCI indicates paging for the UE's paging subgroup.

Alternately at step 1050, in some embodiments, the UE receives an LPWUS in the monitored LPWUS-O, and the UE determines if the LPWUS indicates paging for UE's paging subgroup.

At step 1060, in some embodiments, if the DCI indicates paging for the UE's paging subgroup, the UE monitors the determined PO, the UE monitors the PDCCH addressed to the P-RNTI in the PO, and the UE receives the PDCCH addressed to the P-RNTI (i.e., DCI) in the determined PO.

Alternately at step 1060, in some embodiments, if the LPWUS indicates paging for the UE's paging subgroup, the UE monitors determined PO, the UE monitors the PDCCH addressed to the P-RNTI in the PO, and the UE receives the PDCCH addressed to the P-RNTI (i.e., DCI) in the determined PO.

At step 1070, the UE determines if the DCI includes the fourth segment of the UE's paging identity. If the fourth segment of the UE's paging identity is included in the DCI (i.e., the segment in the DCI matches the corresponding segment of the UE's paging identity), the UE considers that the paging is received for the UE and responds to the paging. In some embodiments, the number of bits in the fourth segment can be ‘number of bits in the UE's paging identity-(number of bits of first segment+number of bits of second segment+number of bits of third segment)’. In some embodiments, the number of bits in the fourth segment can be pre-defined or configured/signaled by the gNB. In some embodiments, the starting bit number, ending bit number/number of bits of the fourth segment can be pre-defined or configured/signaled by the gNB.

Although FIG. 10 illustrates one example procedure for paging 1000, various changes may be made to FIG. 10. For example, while shown as a series of steps, various steps in FIG. 10 could overlap, occur in parallel, occur in a different order, occur any number of times, be omitted, or replaced by other steps.

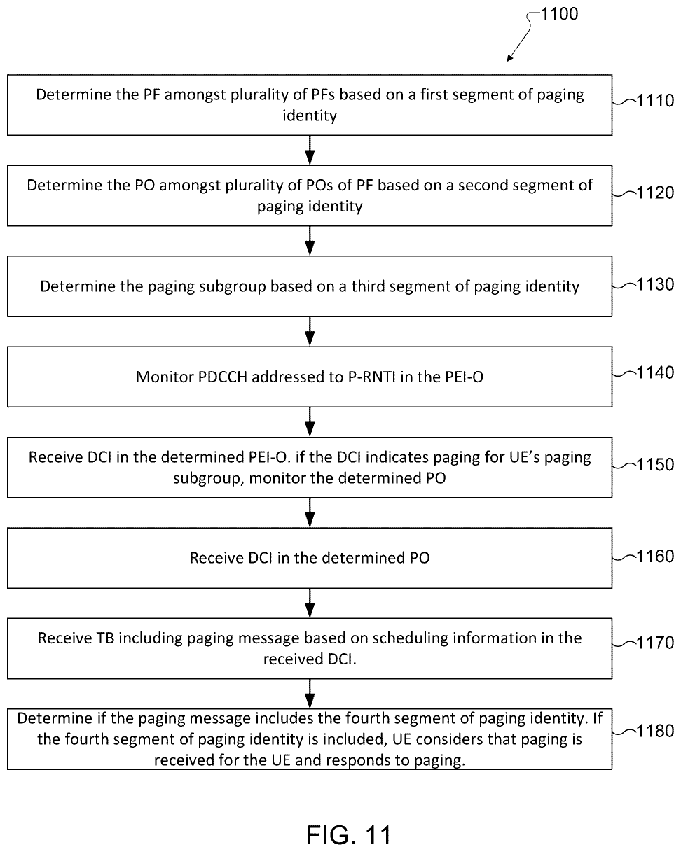

FIG. 11 illustrates another example procedure for paging 1100 according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for paging could be used without departing from the scope of this disclosure.

In the example of FIG. 11, the paging identity of a UE (such as UE 116 of FIG. 1) may be divided into at least four segments. In some embodiments, the paging identity of the UE is divided into the at least four segments by the UE. In some embodiments, the paging identity of the UE is divided into the at least four segments by a gNB (such as BS 102 of FIG. 1).

Procedure 1100 begins at step 1110. At step 1110, the UE determines a PF amongst a plurality of PFs based on a first segment of the UE's paging identity. In some embodiments, if the number of the paging frame is N, the number of bits (k1) in the first segment can be log2(N). In some embodiments, the number of bits (k1) in the first segment can be pre-defined or configured/signaled by the gNB. In some embodiments, the starting bit number, ending bit number/number of bits of first segment can be pre-defined or configured/signaled by the gNB.

In some embodiments, the first segment can be k1 lsbs of the UE's paging identity. In some embodiments, the first segment can be k1 bits (lsb to msb) following the second segment or third segment. In some embodiments, the first segment is the UE's paging identity mod N, or the first segment is (the UE's paging identity/N1) mod N or the first segment is floor [(the UE's paging identity/N1) mod N].

At step 1120, the UE determines a PO amongst a plurality of POs of the PF based on a second segment of the UE's paging identity. In some embodiments, if the number of POs is N1, the number of bits (k2) in the second segment can be log2(N1). In some embodiments, the number of bits (k2) in the second segment can be pre-defined or configured/signaled by the gNB. In some embodiments, the starting bit number, ending bit number/number of bits of the second segment can be pre-defined or configured/signaled by the gNB.

In some embodiments, the second segment can be k2 lsbs of the UE's paging identity. In some embodiments, the second segment can be k2 bits (lsb to msb) following the first segment or third segment. In some embodiments, the second segment is the UE's paging identity mod N1, or the second segment is (the UE's paging identity/N) mod N1 or the second segment is floor [(the UE's paging identity/N) mod N1].

At step 1130, the UE determines a paging subgroup based on a third segment of the paging identity. In some embodiments, if the number of paging subgroups is N2, the number of bits (k3) in the third segment can be log2(N2). In some embodiments, the number of bits (k3) in the third segment can be pre-defined or configured/signaled by the gNB. In some embodiments, the starting bit number, ending bit number/number of bits of third segment can be pre-defined or configured/signaled by the gNB.

In some embodiments, the third segment can be k3 lsbs of the UE's paging identity. In some embodiments, the third segment can be k3 bits (lsb to msb) following the first segment or the second segment. In some embodiments, the third segment is the UE's paging identity mod N2 or the third segment is (the UE's paging identity/N) mod N2 or the third segment is floor [(the UE's paging identity/N) mod N2] or the third segment is (the UE's paging identity/N1) mod N2 or the third segment is floor [(the UE's paging identity/N1) mod N2] or the third segment is [the UE's paging identity/(N*N1)] mod N2 or the third segment is floor {[the UE's paging identity/(N*N1)] mod N2}.

At step 1140, in some embodiments, the UE monitors the PDCCH addressed to the P-RNTI in the PEI-O.

Alternately at step 1140, in some embodiments, the UE monitors an LPWUS-O for the LPWUS.

At step 1150, in some embodiments, the UE receives the PDCCH addressed to the P-RNTI (i.e., DCI) in the determined PEI-O, and the UE determines if the DCI indicates paging for the UE's paging subgroup.

Alternately at step 1150, in some embodiments, the UE receives the LPWUS in the monitored LPWUS-O, and the UE determines if the LPWUS indicates paging for the UE's paging subgroup.

At step 1160, in some embodiments, if the DCI indicates paging for the UE's paging subgroup, the UE monitors determined PO, the UE monitors the PDCCH addressed to the P-RNTI in the PO, and the UE receives the PDCCH addressed to the P-RNTI (i.e., DCI) in the determined PO.

Alternately at step 1160, in some embodiments, if the LPWUS indicates paging for the UE's paging subgroup, the UE monitors the determined PO, the UE monitors the PDCCH addressed to e P-RNTI in the PO, and the UE receives the PDCCH addressed to the P-RNTI (i.e., DCI) in the determined PO.

At step 1170, the UE receives a TB including a paging message based on the scheduling information in the received DCI in the PO.

At step 1180, the UE determines if the paging message includes the fourth segment of the UE's paging identity. If the fourth segment of the UE's paging identity is included in the paging message (i.e., the segment in the paging message matches the corresponding segment of the UE's paging identity), the UE considers that paging is received for the UE and responds to the paging. In some embodiments, the number of bits in fourth segment can be ‘number of bits in the UE's paging identity-(number of bits of first segment+number of bits of second segment+number of bits of third segment)’. In some embodiments, the number of bits in the fourth segment can be pre-defined or configured/signaled by the gNB. In some embodiments, the starting bit number, ending bit number/number of bits of the fourth segment can be pre-defined or configured/signaled by the gNB.

Although FIG. 11 illustrates one example procedure for paging 1100, various changes may be made to FIG. 11. For example, while shown as a series of steps, various steps in FIG. 11 could overlap, occur in parallel, occur in a different order, occur any number of times, be omitted, or replaced by other steps.

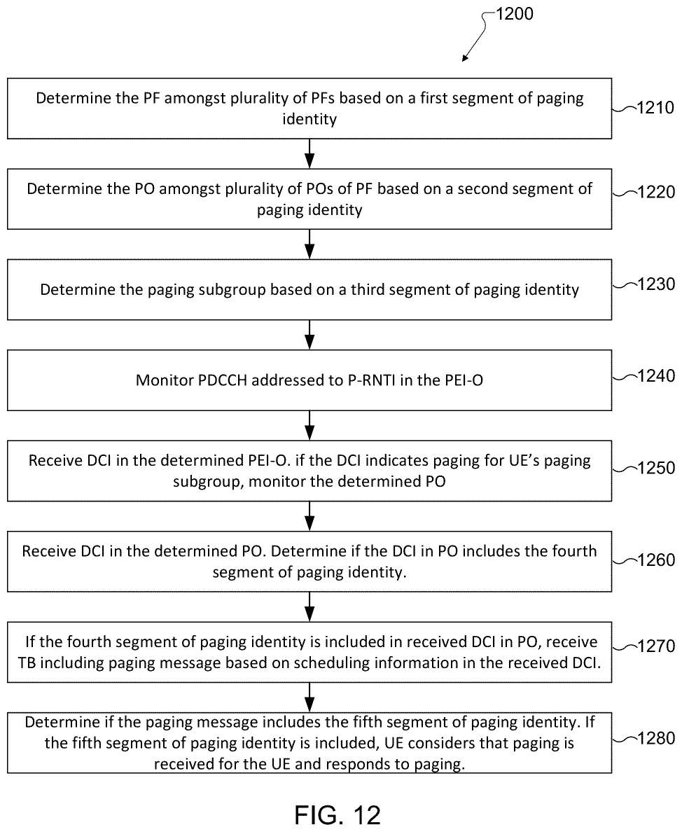

FIG. 12 illustrates another example procedure for paging 1200 according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a procedure for paging could be used without departing from the scope of this disclosure.

In the example of FIG. 12, the paging identity of a UE (such as UE 116 of FIG. 1) may be divided into at least five segments. In some embodiments, the paging identity of the UE is divided into the at least five segments by the UE. In some embodiments, the paging identity of the UE is divided into the at least five segments by a gNB (such as BS 102 of FIG. 1).

Procedure 1200 begins at step 1210. At step 1210, the UE determines a PF amongst a plurality of PFs based on a first segment of the UE's paging identity. In some embodiments, if the number of the paging frame is N, the number of bits (k1) in the first segment can be log2(N). In some embodiments, the number of bits (k1) in the first segment can be pre-defined or configured/signaled by the gNB. In some embodiments, the starting bit number, ending bit number/number of bits of first segment can be pre-defined or configured/signaled by the gNB.

In some embodiments, the first segment can be k1 lsbs of the UE's paging identity. In some embodiments, the first segment can be k1 bits (lsb to msb) following the second segment or third segment. In some embodiments, the first segment is the UE's paging identity mod N, or the first segment is (the UE's paging identity/N1) mod N or the first segment is floor [(UE's paging identity/N1) mod N].

At step 1210, the UE determines a PO amongst a plurality of POs of the PF based on a second segment of the UE's paging identity. In some embodiments, if the number of POs is N1, the number of bits (k2) in the second segment can be log2(N1). In some embodiments, the number of bits (k2) in the second segment can be pre-defined or configured/signaled by the gNB. In some embodiments, the starting bit number, ending bit number/number of bits of second segment can be pre-defined or configured/signaled by the gNB.

In some embodiments, the second segment can be k2 lsbs of the UE's paging identity. In some embodiments, the second segment can be k2 bits (lsb to msb) following the first segment or third segment. In some embodiments, the second segment is the UE's paging identity mod N1, or the second segment is (the UE's paging identity/N) mod N1 or the second segment is floor [(the UE's paging identity/N) mod N1].

At step 1230, the UE determines a paging subgroup based on a third segment of the paging identity. In some embodiments, if the number of paging subgroups is N2, the number of bits (k3) in the third segment can be log2(N2). In some embodiments, the number of bits (k3) in the third segment can be pre-defined or configured/signaled by the gNB. In some embodiments, the starting bit number, ending bit number/number of bits of third segment can be pre-defined or configured/signaled by the gNB.

In some embodiments, the third segment can be k3 lsbs of the UE's paging identity. In some embodiments, the third segment can be k3 bits (lsb to msb) following the first segment or second segment. In some embodiments, the third segment is the UE's paging identity mod N2 or the third segment is (the UE's paging identity/N) mod N2 or the third segment is floor [(UE's paging identity/N) mod N2] or the third segment is (the UE's paging identity/N1) mod N2 or the third segment is floor [(the UE's paging identity/N1) mod N2] or the third segment is [the UE's paging identity/(N*N1)] mod N2 or the third segment is floor {[the UE's paging identity/(N*N1)] mod N2}.

At step 1240, in some embodiments, the UE monitors the PDCCH addressed to the P-RNTI in the PEI-O.

Alternately at step 1240, in some embodiments, the UE monitors an LPWUS-O for an LPWUS.

At step 1250, in some embodiments, the UE receives the PDCCH addressed to the P-RNTI (i.e., DCI) in the determined PEI-O, and the UE determines if the DCI indicates paging for the UE's paging subgroup.

Alternately at step 1250, in some embodiments, the UE receives the LPWUS in the monitored LPWUS-O, and the UE determines if the LPWUS indicates paging for the UE's paging subgroup.

At step 1260, in some embodiments, if the DCI indicates paging for the UE's paging subgroup, the UE monitors the determined PO, the UE monitors the PDCCH addressed to the P-RNTI in the PO, and the UE receives the PDCCH addressed to the P-RNTI (i.e., DCI) in the determined PO.

Alternately at step 1260, in some embodiments, if the LPWUS indicates paging for the UE's paging subgroup, the UE monitors the determined PO, the UE monitors the PDCCH addressed to the P-RNTI in the PO, and the UE receives the PDCCH addressed to the P-RNTI (i.e., DCI) in the determined PO.

At step 1270, the UE determines if the DCI includes the fourth segment of the UE's paging identity. If the fourth segment of the UE's paging identity is included in the DCI (i.e., the segment in the DCI matches the corresponding segment of the UE's paging identity), the UE receives a TB including a paging message based on the scheduling information in the received DCI in the PO. In some embodiments, the number of bits in the fourth segment can be pre-defined or configured/signaled by the gNB.

At step 1280, the UE determines if the paging message includes the fifth segment of UE's paging identity. If the fifth segment of UE's paging identity is included in the paging message (i.e., the segment in the paging message matches the corresponding segment of the UE's paging identity), the UE considers that paging is received for the UE and responds to the paging. In some embodiments, the number of bits in the fifth segment can be ‘number of bits in the UE's paging identity-(number of bits of first segment+number of bits of second segment+number of bits of third segment+number of bits of fourth segment)’. In some embodiments, the number of bits in the fifth segment can be pre-defined or configured/signaled by the gNB.

Although FIG. 12 illustrates one example procedure for paging 1200, various changes may be made to FIG. 12. For example, while shown as a series of steps, various steps in FIG. 12 could overlap, occur in parallel, occur in a different order, occur any number of times, be omitted, or replaced by other steps.

In some embodiments, the UE monitors an LPWUS-O for an LPWUS. The LPWUS-O may be determined based on a segment (first segment) of the UE's paging identity. If the LPWUS includes a segment (second segment) of the UE's paging identity (i.e., the segment in the LPWUS matches the corresponding segment of the UE's paging identity), the UE considers that paging is received by the UE and the UE responds to the paging.

In some embodiments, the UE monitors an LPWUS-O for an LPWUS. The LPWUS-O may be determined based on a segment (first segment) of the UE's paging identity. If the LPWUS includes a segment (second segment) of the UE's paging identity (i.e., the segment in the LPWUS matches the corresponding segment of the UE's paging identity), the UE monitors the PEI-O or PO for paging. The segment of the UE's paging identity included in the LPWUS may be different from the segment of the UE's paging identity used to determine the LPWUS-O.

In some embodiments, the UE monitors a PO for paging. The PO may be determined based on a segment of the UE's paging identity. If the DCI received in the PO includes a segment of the UE's paging identity (i.e., the segment in the DCI matches the corresponding segment of the UE's paging identity), the UE considers that paging is received by the UE and the UE responds to the paging.

In some embodiments, the UE monitors a PO for paging. The PO may be determined based on a segment of the UE's paging identity. If the DCI received in the PO includes a segment of the UE's paging identity (i.e., the segment in DCI matches the corresponding segment of the UE's paging identity), the UE receives a TB including a paging message based on the scheduling information in the DCI. If the paging message received includes a segment of the UE's paging identity (i.e., the segment in the paging message matches the corresponding segment of the UE's paging identity), the UE considers that paging is received by the UE and the UE responds to the paging.

In some embodiments, a segment of the UE's paging identity may be included in a DCI of a PDCCH addressed to a P-RNTI transmitted/received in a PO, a segment of the UE's paging identity may be included in a paging message and a segment of the UE's paging identity may be included in an LPWUS. Each of these segments can be different. The UE monitors an LPWUS-O for the LPWUS. If the segment included in the LPWUS is the segment of the UE's paging identity, the UE monitors the PO. The UE receives DCI in PO. If the segment included in the DCI is the segment of the UE's paging identity (i.e., the segment in DCI matches the corresponding segment of the UE's paging identity), the UE receives a paging message scheduled by the DCI. If the segment included in the paging message is the segment of the UE's paging identity (i.e., the segment in the paging message matches the corresponding segment of the UE's paging identity), the UE considers that the paging is received by the UE and the UE responds to the paging.

In some embodiments, a segment of the UE's paging identity may be included in a DCI of a PDCCH addressed to a P-RNTI transmitted/received in a PO and a segment of the UE's paging identity may be included in an LPWUS. Each of these segments can be different. The UE monitors an LPWUS-O for the LPWUS. If the segment included in the LPWUS is the segment of the UE's paging identity (i.e., the segment in the LPWUS matches the corresponding segment of the UE's paging identity), the UE monitors the PO. The UE receives DCI in the PO. If the segment included in the DCI is the segment of the UE's paging identity (i.e., the segment in the DCI matches the corresponding segment of the UE's paging identity), the UE considers that paging is received by the UE and the UE responds to the paging.

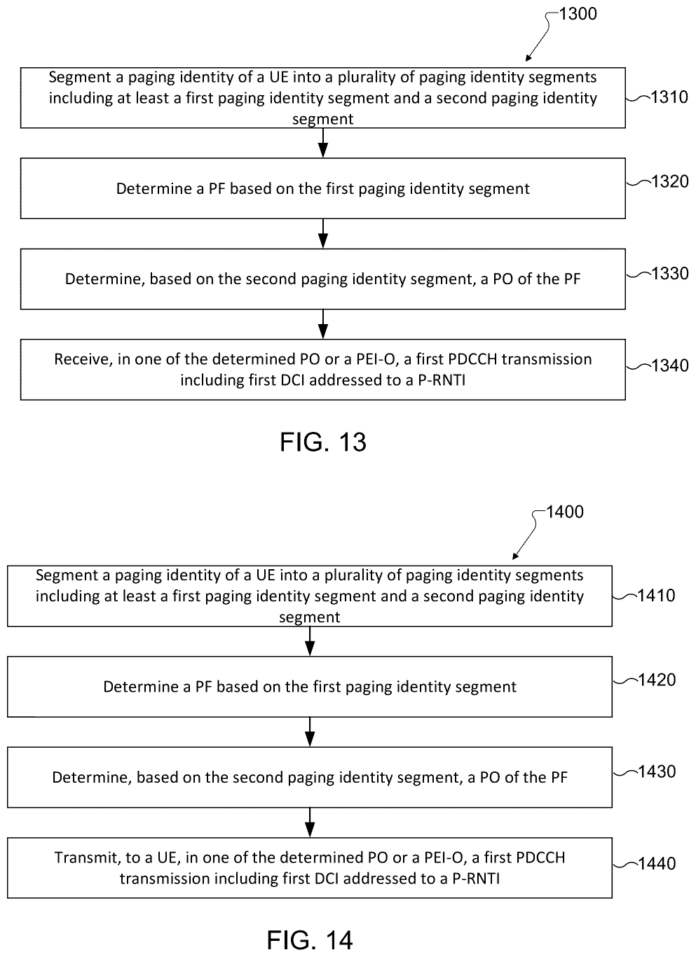

FIG. 13 illustrates an example method for paging by segmenting paging identity 1300 according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for paging by segmenting paging identity could be used without departing from the scope of this disclosure.

In the example of FIG. 13, method 1300 begins at step 1310. At step 1310, a UE (such as UE 116 of FIG. 1) segments a paging identity of the UE into a plurality of paging identity segments including at least a first paging identity segment and a second paging identity segment.

At step 1320, the UE determines a PF based on the first paging identity segment.

At step 1330, the UE determines, based on the second paging identity segment, a PO of the PF.

At step 1340, the UE receives, in one of the determined PO or a PEI-O, a first PDCCH transmission including first DCI addressed to a P-RNTI.

In some embodiments, the plurality of paging identity segments further includes a third paging identity segment, and the UE receives, based on scheduling information in the first DCI, a transport block including a paging message. In these embodiments, the UE also determines whether the paging message includes the third paging identity segment, and in response to a determination that the paging message includes the third paging identity segment, initiates a paging response.

In some embodiments, the plurality of paging identity segments further includes a third paging identity segment, and the UE determines whether the first DCI includes the third paging identity segment. In these embodiments, the UE also, in response to a determination that the first DCI includes the third paging identity segment, initiates a paging response.

In some embodiments, the plurality of paging identity segments further includes a third paging identity segment and a fourth paging identity segment, and the UE determines whether the first DCI includes the third paging identity segment. In response to a determination that the first DCI includes the third paging identity segment, the UE receives, based on scheduling information in the first DCI, a transport block including a paging message. In these embodiments, the UE also determining whether the paging message includes the fourth paging identity segment, and in response to a determination that the paging message includes the fourth paging identity segment, initiates a paging response.

In some embodiments, the plurality of paging identity segments further includes a third paging identity segment and a fourth paging identity segment, and the UE determines, based on the third paging identity segment, a paging subgroup of the UE, and determines whether the first DCI indicates paging for the paging subgroup of the UE. In response to a determination that the first DCI indicates the paging subgroup of the UE, the UE receives, based on scheduling information in the first DCI, a transport block including a paging message. In these embodiments, the UE also determines whether the paging message includes the fourth paging identity segment, and in response to a determination that the paging message includes the fourth paging identity segment, initiates a paging response.

In some embodiments, the plurality of paging identity segments further includes a third paging identity segment and a fourth paging identity segment, and the UE determines based on the third paging identity segment, a paging subgroup of the UE, and determines whether the first DCI received in the PEI-O indicates paging for the paging subgroup of the UE. In response to a determination that the first DCI indicates paging for the paging subgroup of the UE, the UE receives, a second PDCCH transmission including a second DCI in the determined PO. In these embodiments, the UE also determining whether the second DCI includes the fourth paging identity segment, and in response to a determination that the second DCI includes the fourth paging identity segment, initiates a paging response.

In some embodiments, the plurality of paging identity segments further includes a third paging identity segment and a fourth paging identity segment, and the UE determines based on the third paging identity segment, a paging subgroup of the UE, and determines whether the first DCI in the PEI-O indicates paging for the paging subgroup of the UE. In response to a determination that the first DCI indicates paging for the paging subgroup of the UE, the UE receives a second PDCCH transmission including second DCI in the determined PO. In these embodiments, the UE also receives, based on scheduling information in the second DCI, a transport block including a paging message, and determines whether the paging message includes the fourth paging identity segment. In response to a determination that the paging message includes the fourth paging identity segment, the UE initiates a paging response.

Although FIG. 13 illustrates one example method for paging by segmenting paging identity 1300, various changes may be made to FIG. 13. For example, while shown as a series of steps, various steps in FIG. 13 could overlap, occur in parallel, occur in a different order, occur any number of times, be omitted, or replaced by other steps.

FIG. 14 illustrates another example method for paging by segmenting paging identity 1400 according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for paging by segmenting paging identity could be used without departing from the scope of this disclosure.

In the example of FIG. 14, method 1400 begins at step 1410. At step 1410, a BS (such as BS 102 of FIG. 1) segments a paging identity of the UE (such as UE 116 of FIG. 1) into a plurality of paging identity segments including at least a first paging identity segment and a second paging identity segment.

At step 1420, the BS determines a PF based on the first paging identity segment.

At step 1430, the BS determines, based on the second paging identity segment, a PO of the PF.

At step 1440, the BS transmits, to the UE, in one of the determined PO or a PEI-O, a first PDCCH transmission including first DCI addressed to a P-RNTI.

In some embodiments, the plurality of paging identity segments further includes a third paging identity segment, and the BS transmits, to the UE, based on scheduling information in the first DCI, a transport block including a paging message including the third paging identity segment. In the embodiments, the BS also receives, based on the paging message including the third paging identity segment, a paging response from the UE.

In some embodiments, the plurality of paging identity segments further includes a third paging identity segment, and the first DCI includes the third paging identity segment. In these embodiments, the BS also receives, based on the first DCI including the third paging identity segment, a paging response from the UE.

In some embodiments, the plurality of paging identity segments further includes a third paging identity segment and a fourth paging identity segment, and the first DCI includes the third paging identity segment. In these embodiments, the BS also transmits, to the UE, based on scheduling information in the first DCI, a transport block including a paging message including the fourth paging identity segment, and receives, based on the paging message including the fourth paging identity segment, a paging response from the UE.

In some embodiments, the plurality of paging identity segments further includes a third paging identity segment and a fourth paging identity segment, the third paging identity segment indicates a paging subgroup of the UE, and the first DCI indicates paging for the paging subgroup of the UE. In these embodiments, the BS also transmits, based on scheduling information in the first DCI, a transport block including a paging message including the fourth paging identity segment, and receives, based on the paging message including the fourth paging identity segment, a paging response from the UE.

In some embodiments, the plurality of paging identity segments further includes a third paging identity segment and a fourth paging identity segment, the third paging identity segment indicates a paging subgroup of the UE, the first DCI is transmitted in the PEI-O, and the first DCI indicates paging for the paging subgroup of the UE. In these embodiments, the BS also transmit a second PDCCH transmission including second DCI including the fourth paging identity segment in the determined PO, and receives, based on the second DCI including the fourth paging identity segment, a paging response from the UE.

Although FIG. 14 illustrates one example method for paging by segmenting paging identity 1400, various changes may be made to FIG. 14. For example, while shown as a series of steps, various steps in FIG. 14 could overlap, occur in parallel, occur in a different order, occur any number of times, be omitted, or replaced by other steps.

As noted above, various embodiments of the present disclosure provide for cell barring.

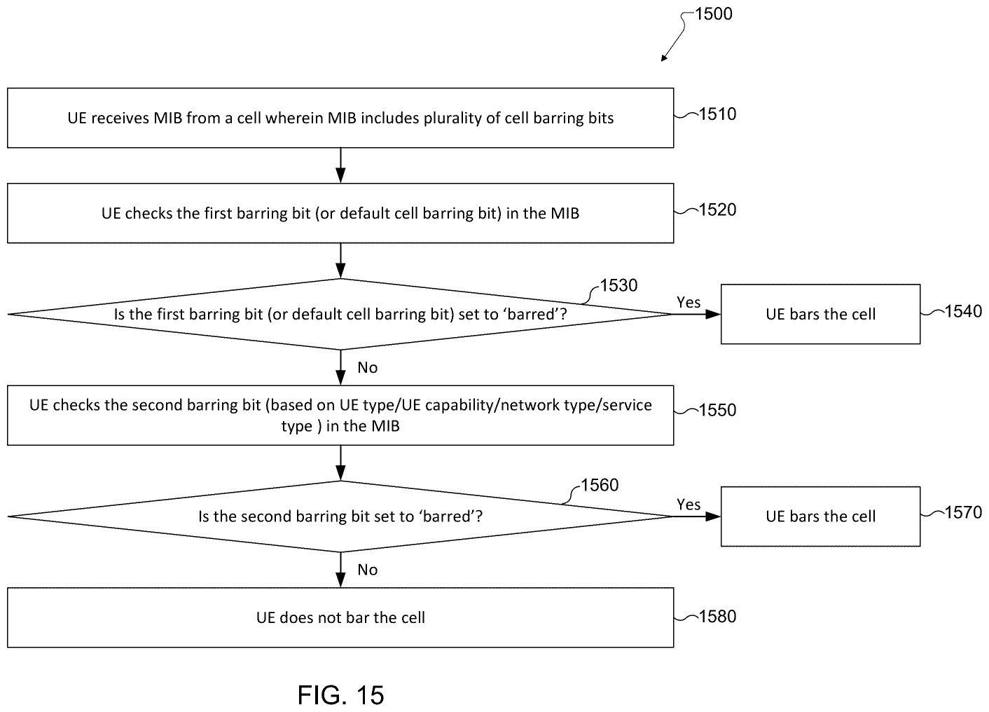

FIG. 15 illustrates an example procedure for barring in wireless communication system 1500 according to embodiments of the present disclosure. An embodiment of the procedure illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a procedure for barring in wireless communication system could be used without departing from the scope of this disclosure.

In the example of FIG. 15, in some embodiments, multiple bits or a bitmap for cell barring may be included in a MIB. Each of these bits uniquely maps to a different UE type/UE capability/network type/service type (e.g., NTN capable UEs, ATG capable UEs, reduced capability UEs [or reduced capability UEs supporting 1RX chain or 2RX chain], enhanced reduced capability UEs [or enhanced reduced capability UEs supporting 1RX chain or 2RX chain], UAV, UEs supporting NES, UEs supporting Cell DTX/DRX, UE supporting SSB/RACH/paging adaptation [time domain or spatial domain], UEs supporting sidelink, UEs supporting MBS, UEs supporting narrow band, etc.).

In some embodiments, one of these cell barring bits could be a default barring bit.

Procedure 1500 begins at step 1510. At step 1510, a UE (such as UE 116 of FIG. 1) receives a MIB from a cell, wherein the MIB includes a plurality of cell barring bits.

At step 1510, the UE checks the first barring bit (or default cell barring bit) in the MIB.

At step 1530, if the first barring bit (or default cell barring bit) is set to ‘barred’, the UE bars the cell at step 1540. At step 1540, the UE may bar the cell for a pre-defined or a configured time. Otherwise, if the first barring bit (or default cell barring bit) is not set to ‘barred’ or set to ‘notbarred’, the procedure proceeds to step 1550.

At step 1550, the UE checks the second barring bit (the second bit is determined based on the UE type/UE capability/network type/service type [e.g., NTN capable UEs, ATG capable UEs, reduced capability UEs {or reduced capability UEs supporting 1RX chain or 2RX chain}, enhanced reduced capability UEs, UAV, UEs supporting NES, UEs supporting Cell DTX/DRX, UE supporting time domain SSB/RACH/paging adaptation, UEs supporting sidelink, UEs supporting MBS, UEs supporting narrow band, etc.]) in the MIB. For example:
if the UE is NTN-capable, the second barring bit in the MIB is the barring bit in the MIB for NTN UE/connectivity to NTN
if the UE is ATG-capable, the second barring bit in the MIB is the barring bit in the MIB for ATG UE/connectivity to ATG
if the UE is NES-capable, the second barring bit in the MIB is the barring bit in the MIB for NES capable UE/NES capable UE supporting cell DTX/DRX/NES capable UE supporting SSB/RACH/paging adaptation
if the UE is a Redcap UE with 1RX chain, the second barring bit in the MIB is the barring bit in the MIB for a redcap UE with 1RX chain
if the UE is a Redcap UE with 2RX chain, the second barring bit in the MIB is the barring bit in the MIB for a redcap UE with 2RX chain
if the UE is an eRedcap UE with 1RX chain, the second barring bit in the MIB is the barring bit in the MIB for an eRedcap UE with 1RX chain
if the UE is an eRedcap UE with 2RX chain, the second barring bit in the MIB is the barring bit in the MIB for an eRedcap UE with 2RX chain
If the UE is UAV, the second barring bit in the MIB is the barring bit in the MIB for UAV.

At step 1560, if the second barring bit is set to ‘barred’, the UE bars the cell at step 1570. At step 1570 the UE may bar the cell for a pre-defined or a configured time. Otherwise, if the second barring bit is not set to ‘barred’ or set to ‘notbarred’, the does not bar the cell at step 1580.

In some embodiments, the MIB in the procedure of FIG. 15 can be a PBCH payload instead of a MIB. The UE may receive the MIB after determining that the cell is not barred based on the PBCH payload as per the procedure of FIG. 15.

In some embodiments, one or more intra frequency reselection bits can be included in the MIB/PBCH payload. The intra frequency reselection bit can be common for all cell barring bits in the MIB/PBCH payload or the intra frequency reselection bit can be separate for each cell barring bit or the intra frequency reselection bit can be separate for a group of cell barring bits.

In some embodiments, if the UE bars the cell and the intra frequency reselection bit corresponding to the cell barring bit based on which the UE bars the cell is set to not allowed, the UE bars the frequency/carrier of the barred cell, or the UE bars the frequency/carrier of the barred cell if the cell is operating on a licensed cell (i.e., the cell is not operating on shared spectrum), or the UE bars the frequency/carrier of the barred cell if the cell is operating on shared spectrum and the cell belongs to the UE's registered PLMN. The UE does not bar the frequency/carrier of the barred cell if the cell is operating on shared spectrum and the cell does not belong to the UE's registered PLMN, or the UE does not bar the frequency/carrier of the barred cell if the cell is operating on shared spectrum.

In some embodiments, if the UE bars the cell and the intra frequency reselection bit corresponding to the cell barring bit based on which UE bars the cell is set to allowed, the UE does not bar the frequency/carrier of the barred cell.

Although FIG. 15 illustrates one example procedure for barring in wireless communication system 1500, various changes may be made to FIG. 15. For example, while shown as a series of steps, various steps in FIG. 15 could overlap, occur in parallel, occur in a different order, occur any number of times, be omitted, or replaced by other steps.

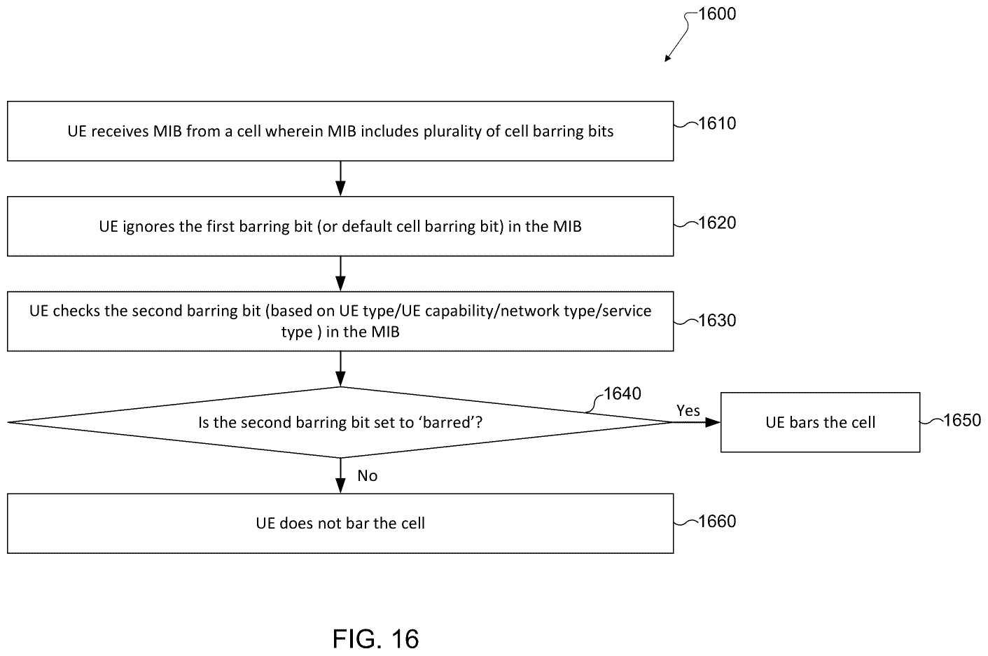

FIG. 16 illustrates another example procedure for barring in wireless communication system 1600 according to embodiments of the present disclosure. An embodiment of the procedure illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of a procedure for barring in wireless communication system could be used without departing from the scope of this disclosure.

In the example of FIG. 16, in some embodiments, multiple bits or a bitmap for cell barring may be included in a MIB. Each of these bits uniquely maps to a different UE type/UE capability/network type/service type (e.g., NTN capable UEs, ATG capable UEs, reduced capability UEs [or reduced capability UEs supporting 1RX chain or 2RX chain], enhanced reduced capability UEs, UAV, UEs supporting NES, UEs supporting Cell DTX/DRX, UE supporting time domain SSB/RACH/paging adaptation, UEs supporting sidelink, UEs supporting MBS, UEs supporting narrow band, etc.). One of the bits could be a default barring bit. The default barring bit can be referred to as a Cellbarred bit in the MIB.

Procedure 1600 begins at step 1610. At step 1610, a UE (such as UE 116 of FIG. 1) receives a MIB from a cell, the wherein the MIB includes a plurality of cell barring bits.

At step 1620, the UE ignores the first barring bit (or default cell barring bit) in the MIB.

At step 1630, the UE checks the second barring bit (the second bit is determined based on the UE type/UE capability/network type/service type [e.g., NTN capable UEs, ATG capable UEs, reduced capability UEs {or reduced capability UEs supporting 1RX chain or 2RX chain}, enhanced reduced capability UEs, UAV, UEs supporting NES, UEs supporting Cell DTX/DRX, UE supporting time domain SSB/RACH/paging adaptation, UEs supporting sidelink, UEs supporting MBS, UEs supporting narrow band, etc.]) in the MIB. For example:

if the UE is NTN-capable, the second barring bit in the MIB is the barring bit in the MIB for an NTN UE/connectivity to NTN
if the UE is ATG-capable, the second barring bit in the MIB is the barring bit in the MIB for an ATG UE/connectivity to ATG
if the UE is NES-capable, the second barring bit in the MIB is the barring bit in the MIB for an NES capable UE/NES capable UE supporting cell DTX/DRX/NES capable UE supporting SSB/RACH/paging adaptation
if the UE is a Redcap UE with 1RX chain, the second barring bit in MIB is the barring bit in the MIB for a redcap UE with 1RX chain
if the UE is a Redcap UE with 2RX chain, the second barring bit in the MIB is the barring bit in the MIB for a redcap UE with 2RX chain
if the UE is an eRedcap UE with 1RX chain, the second barring bit in the MIB is the barring bit in the MIB for an eRedcap UE with 1RX chain
if the UE is an eRedcap UE with 2RX chain, the second barring bit in the MIB is the barring bit in the MIB for an eRedcap UE with 2RX chain
If the UE is a UAV, the second barring bit in the MIB is the barring bit in the MIB for UAV.

At step 1640, if the second barring bit is set to ‘barred’, the UE bars the cell at step 1650. At step 1650, the UE may bar the cell for a pre-defined or a configured time. Otherwise, if the second barring bit is not set to ‘barred’ or set to ‘not barred’, the UE does not bar the cell at step 1660.

In some embodiments, the MIB in the procedure of FIG. 16 can be a PBCH payload instead of a MIB.

In some embodiments, one or more intra frequency reselection bits can be included in the MIB/PBCH payload. The intra frequency reselection bit can be common for all cell barring bits in the MIB/PBCH payload or the intra frequency reselection bit can be separate for each cell barring bit or the intra frequency reselection bit can be separate for a group of cell barring bits.

In some embodiments, if the UE bars the cell and the intra frequency reselection bit corresponding to the cell barring bit based on which the UE bars the cell is set to not allowed, the UE bars the frequency/carrier of the barred cell, or the UE bars the frequency/carrier of the barred cell if the cell is operating on a licensed cell (i.e., the cell is not operating on shared spectrum), or the UE bars the frequency/carrier of the barred cell if the cell is operating on shared spectrum and the cell belongs to the UE's registered PLMN. The UE does not bar the frequency/carrier of the barred cell if the cell is operating on shared spectrum and the cell does not belongs to the UE's registered PLMN, or the UE does not bar the frequency/carrier of the barred cell if the cell is operating on shared spectrum.

In some embodiments, if the UE bars the cell and the intra frequency reselection bit corresponding to the cell barring bit based on which the UE bars the cell is set to allowed, the UE does not bar the frequency/carrier of the barred cell.

Although FIG. 16 illustrates one example procedure for barring in wireless communication system 1600, various changes may be made to FIG. 16. For example, while shown as a series of steps, various steps in FIG. 16 could overlap, occur in parallel, occur in a different order, occur any number of times, be omitted, or replaced by other steps.

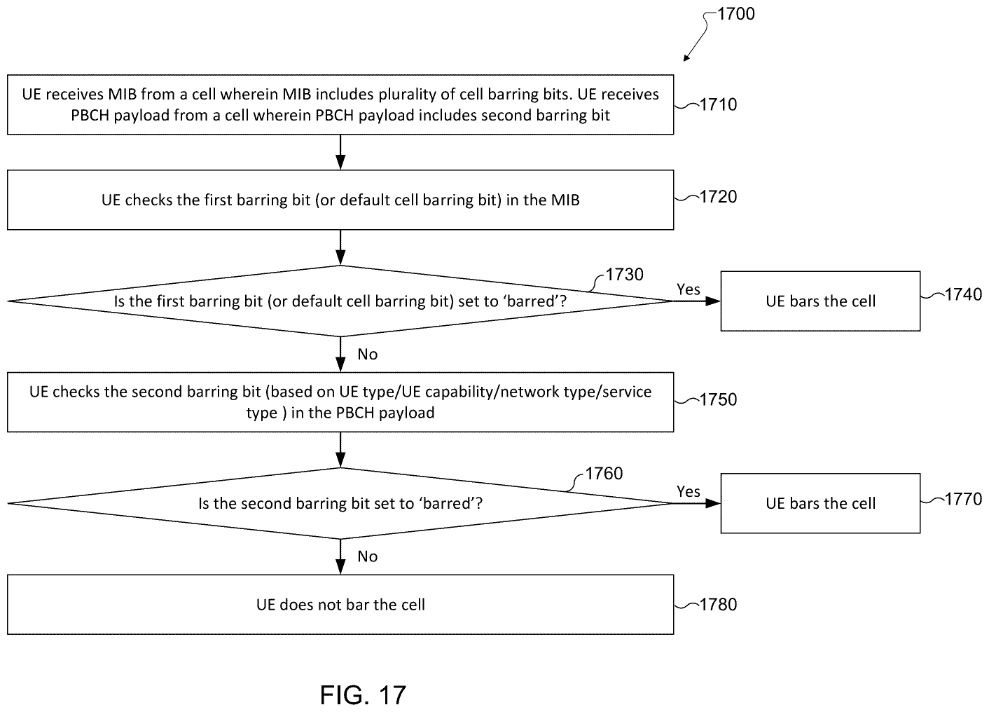

FIG. 17 illustrates another example procedure for barring in wireless communication system 1700 according to embodiments of the present disclosure. An embodiment of the procedure illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of a procedure for barring in wireless communication system could be used without departing from the scope of this disclosure.

In the example of FIG. 17, in some embodiments, multiple bits or a bitmap for cell barring may be included in a MIB and PBCH payload. Each of these bits uniquely maps to a different UE type/UE capability/network type/service type (e.g., NTN capable UEs, ATG capable UEs, reduced capability UEs [or reduced capability UEs supporting 1RX chain or 2RX chain], enhanced reduced capability UEs, UAV, UEs supporting NES, UEs supporting Cell DTX/DRX, UE supporting SSB/RACH/paging adaptation [time domain or spatial domain], UEs supporting sidelink, UEs supporting MBS, UEs supporting narrow band, etc.). One of the bits could be a default barring bit. The default barring bit can be referred to as a Cellbarred bit in the MIB.

Procedure 1700 begins at step 1710. At step 1710, a UE (such as UE 116 of FIG. 1) receives a MIB from a cell, wherein the MIB includes a first barring bit (or a default cell barring bit). The UE also receives a PBCH payload from a cell, wherein the PBCH payload includes a second barring bit.

At step 1720, the UE checks the first barring bit (or default cell barring bit) in the MIB.

At step 1730, if the first barring bit (or default cell barring bit) is set to ‘barred’, UE bars the cell at step 1740. At step 1740, the UE may bar the cell for a pre-defined or a configured time. Otherwise, if the first barring bit (or default cell barring bit) is not set to ‘barred’ or set to ‘not barred’, the procedure proceeds to step 1750.

At step 1750, the UE checks the second barring bit (the second bit is determined based on the UE type/UE capability/network type/service type [e.g., NTN capable UEs, ATG capable UEs, reduced capability UEs {or reduced capability UEs supporting 1RX chain or 2RX chain}, enhanced reduced capability UEs, UAV, UEs supporting NES, UEs supporting Cell DTX/DRX, UE supporting time domain SSB/RACH/paging adaptation, UEs supporting sidelink, UEs supporting MBS, UEs supporting narrow band, etc.]) in the PBCH payload. For example:
if the UE is NTN-capable, the second barring bit in the PBCH payload is the barring bit in the PBCH payload for an NTN UE/connectivity to NTN
if the UE is ATG-capable, the second barring bit in the PBCH payload is the barring bit in the PBCH payload for an ATG UE/connectivity to ATG
if the UE is NES-capable, the second barring bit in the PBCH payload is the barring bit in the PBCH payload for an NES capable UE/NES capable UE supporting cell DTX/DRX/NES capable UE supporting SSB/RACH/paging adaptation
if the UE is a Redcap UE with 1RX chain, the second barring bit in the PBCH payload is the barring bit in the PBCH payload for a redcap UE with 1RX chain
if the UE is a Redcap UE with 2RX chain, second barring bit in the PBCH payload is the barring bit in the PBCH payload for a redcap UE with 2RX chain
if the UE is an eRedcap UE with 1RX chain, the second barring bit in the PBCH payload is the barring bit in the PBCH payload for eRedcap UE with 1RX chain
if the UE is an eRedcap UE with 2RX chain, the second barring bit in the PBCH payload is the barring bit in the PBCH payload for an eRedcap UE with 2RX chain
If the UE is a UAV, the second barring bit in the PBCH payload is the barring bit in the PBCH payload B for UAV.

At step 1760, if the second barring bit is set to ‘barred’, the UE bars the cell at step 1770. At step 1770, the UE may bar the cell for a pre-defined or a configured time. Otherwise, if the second barring bit is not set to ‘barred’ or set to ‘not barred’, the does not bar the cell at step 1780.

Although FIG. 17 illustrates one example procedure for barring in wireless communication system 1700, various changes may be made to FIG. 17. For example, while shown as a series of steps, various steps in FIG. 17 could overlap, occur in parallel, occur in a different order, occur any number of times, be omitted, or replaced by other steps.

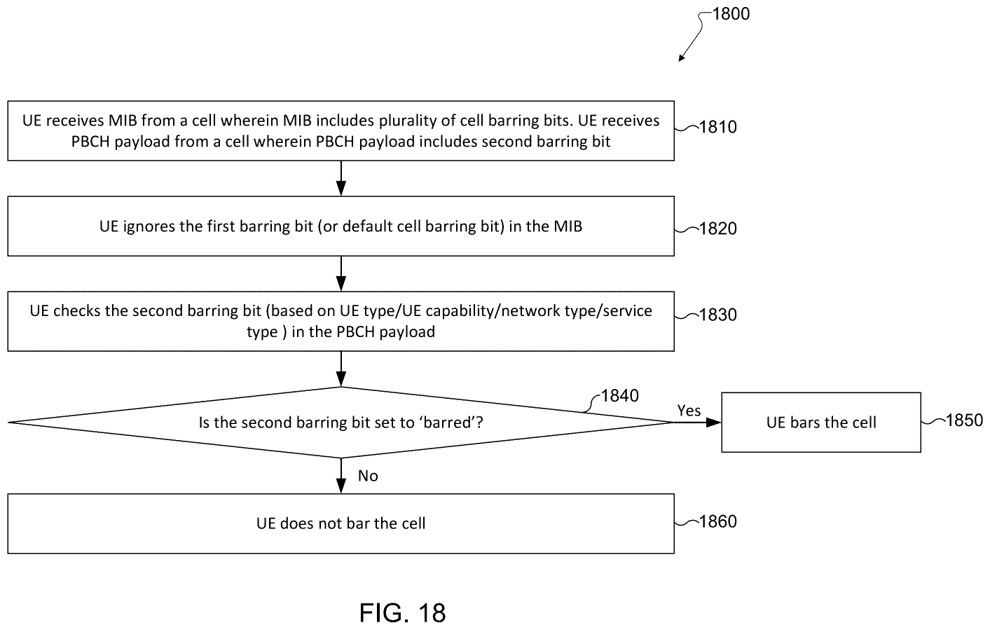

FIG. 18 illustrates another example procedure for barring in wireless communication system 1800 according to embodiments of the present disclosure. An embodiment of the procedure illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments of a procedure for barring in wireless communication system could be used without departing from the scope of this disclosure.

In the example of FIG. 18, in some embodiments, multiple bits or a bitmap for cell barring may be included in a MIB. Each of these bits uniquely maps to a different UE type/UE capability/network type/service type (e.g., NTN capable UEs, ATG capable UEs, reduced capability UEs [or reduced capability UEs supporting 1RX chain or 2RX chain], enhanced reduced capability UEs, UAV, UEs supporting NES, UEs supporting Cell DTX/DRX, UE supporting time domain SSB/RACH/paging adaptation, UEs supporting sidelink, UEs supporting MBS, UEs supporting narrow band, etc.). One of the bits could be a default barring bit. The default barring bit can be referred to as a Cellbarred bit in the MIB.

Procedure 1800 begins at step 1810. At step 1810, a UE (such as UE 116 of FIG. 1) receives a PBCH payload from a cell, wherein the PBCH payload includes a second barring bit. The UE also receives a MIB from a cell, wherein the MIB includes a first barring bit (or default cell barring bit).

At step 1820, the UE ignores the first barring bit (or default cell barring bit) in the MIB or the UE may receive the MIB after determining that the cell is not barred based on the second barring bit in the PBCH payload.

At step 1830, the UE checks the second barring bit (the second bit is determined based on the UE type/UE capability/network type/service type [e.g., NTN capable UEs, ATG capable UEs, reduced capability UEs {or reduced capability UEs supporting 1RX chain or 2RX chain}, enhanced reduced capability UEs, UAV, UEs supporting NES, UEs supporting Cell DTX/DRX, UE supporting time domain SSB/RACH/paging adaptation, UEs supporting sidelink, UEs supporting MBS, UEs supporting narrow band, etc.]) in the PBCH payload. For example:
if the UE is NTN-capable, the second barring bit in the PBCH payload is the barring bit in the PBCH payload for an NTN UE/connectivity to NTN
if the UE is ATG-capable, the second barring bit in the PBCH payload is the barring bit in the PBCH payload for an ATG UE/connectivity to ATG
if the UE is NES-capable, the second barring bit in the PBCH payload is the barring bit in the PBCH payload for an NES capable UE/NES capable UE supporting cell DTX/DRX/NES capable UE supporting SSB/RACH/paging adaptation
if the UE is a Redcap UE with 1RX chain, the second barring bit in the PBCH payload is the barring bit in the PBCH payload for a redcap UE with 1RX chain
if the UE is a Redcap UE with 2RX chain, the second barring bit in the PBCH payload is the barring bit in the PBCH payload for a redcap UE with 2RX chain
if the UE is an eRedcap UE with 1RX chain, the second barring bit in the PBCH payload is the barring bit in the PBCH payload for an eRedcap UE with 1RX chain
if the UE is an eRedcap UE with 2RX chain, the second barring bit in the PBCH payload is the barring bit in the PBCH payload for an eRedcap UE with 2RX chain
If the UE is a UAV, the second barring bit in the PBCH payload is the barring bit in the PBCH payload for a UAV.

At step 1840, if the second barring bit is set to ‘barred’, the UE bars the cell at step 1850. At step 1850, the UE may bar the cell for a pre-defined or a configured time. Otherwise, if the second barring bit is not set to ‘barred’ or set to ‘not barred’, the UE does not bar the cell.

In some embodiments, the UE supports time domain (and/or spatial domain) SSB and/or RACH and/or paging adaptation. In these embodiments, the UE may receive the MIB and/or SIB1 from a cell. If the SIB1 is received and it includes a NES cell barring bit for SSB and/or RACH and/or paging adaptation, if this bit is set to ‘Not Barred”, the UE does not bar the cell. If the SIB 1 is received and it does not include an NES cell barring bit for SSB and/or RACH and/or paging adaptation, or if a SIB1 is not received, if the Cellbarred bit in the MIB is set to ‘barred”, the UE bars the cell. The UE may bar the cell for a pre-defined or a configured time. Otherwise, If the Cellbarred bit in the MIB is set to ‘not barred”, the UE does not bar the cell.

In some embodiments, the UE supports time domain (and/or spatial domain) SSB and/or RACH and/or paging adaptation and UE is a redcap UE. In these embodiments, the UE may receive the MIB and/or a SIB1 from a cell. If the Cellbarred bit in the MIB is set to ‘barred”, the UE bars the cell. UE may bar the cell for a pre-defined or a configured time. If the Cellbarred bit in the MIB is set to ‘not barred” and if the, SIB 1 is received:
If an NES cell barring bit for SSB and/or RACH and/or paging adaptation is set to ‘Not Barred” and the cell barred bit for redcap UE is set to ‘not barred”, the UE does not bar the cell
If an NES cell barring bit for SSB and/or RACH and/or paging adaptation is set to ‘Not Barred” and the cell barred bit for redcap UE is set to ‘barred”, the UE bars the cell
If an NES cell barring bit for SSB and/or RACH and/or paging adaptation is set to ‘Barred” and the cell barred bit for redcap UE is set to ‘not barred”, the UE bars the cell
If cell barred bit for redcap UE is not present in SIB1: UE bar the cell.
   If the Cellbarred bit in the MIB is set to ‘not barred” and a SIB1 is not received, the UE bars the cell. The UE may bar the cell for a pre-defined or a configured time.

In some embodiments, the UE supports time domain (and/or spatial domain) SSB and/or RACH and/or paging adaptation. In these embodiments, the UE may receive MIB and/or SIB1 from cell. If the Cellbarred bit in the MIB is set to ‘barred”, the UE bars the cell. The UE may bar the cell for a pre-defined or a configured time. If the Cellbarred bit in MIB is set to ‘not barred”, and the SIB1 is received:
If an NES cell barring bit for SSB and/or RACH and/or paging adaptation is set to ‘Not Barred “, the UE does not bar the cell
If an NES cell barring bit for SSB and/or RACH and/or paging adaptation is set to ‘Barred”, the UE bars the cell
If an NES cell barring bit for SSB and/or RACH and/or paging adaptation is not present in the SIB 1, the UE bars the cell.
   If the Cellbarred bit in MIB is set to ‘not barred”, and a SIB1 is not received, the UE bars the cell. The UE may bar the cell for a pre-defined or a configured time.

Although FIG. 18 illustrates one example procedure for barring in wireless communication system 1800, various changes may be made to FIG. 18. For example, while shown as a series of steps, various steps in FIG. 18 could overlap, occur in parallel, occur in a different order, occur any number of times, be omitted, or replaced by other steps.

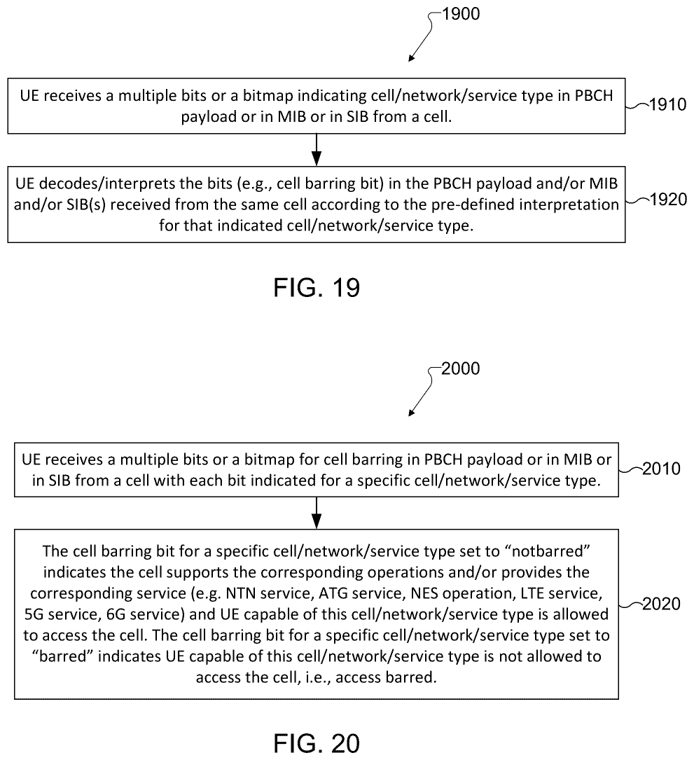

FIG. 19 illustrates another example procedure for barring in wireless communication system 1900 according to embodiments of the present disclosure. An embodiment of the procedure illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of a procedure for barring in wireless communication system could be used without departing from the scope of this disclosure.

In the example of FIG. 19, in some embodiments, multiple bits or a bitmap for cell/network/service type may be included in a PBCH payload or in a MIB or in a SIB of a cell. Each of these bits uniquely maps to a different cell/network/service type (e.g., NTN cell, ATG cell, NES cell, LTE cell, 5G cell, 6G cell). The corresponding bit set to 1 indicate the cell supports the corresponding operations and/or provides the corresponding service (e.g., NTN service, ATG service, NES operation, LTE service, 5G service, 6G service). The corresponding bit set to 0 indicate the cell does not support the corresponding operations and/or provide the corresponding service.

Procedure 1900 begins at step 1910. At step 1910, a UE (such as UE 116 of FIG. 1) receives a PBCH payload and/or MIB and/or SIB(s) from a cell.

At step 1920, the UE interprets/decodes the PBCH payload and/or MIB and/or SIB(s) differently for different a cell/network/service type (e.g., NTN cell, ATG cell, NES cell, LTE cell, 5G cell, 6G cell). In some embodiments, a pre-defined interpretation of the PBCH payload and/or MIB and/or SIB(s) can be specified. If a specific cell/network/service type is indicated in the PBCH payload or in the MIB or in the SIB of a cell, the UE decodes/interprets the bit information in the PBCH payload and/or MIB and/or SIB(s) received from the same cell according to the pre-defined interpretation for that indicated cell/network/service type.

In some embodiments, multiple bits or a bitmap for the cell/network/service type and one barring bit can be included in the PBCH payload or in the MIB or in the SIB of a cell. If a specific cell/network/service type is indicated in the PBCH payload or in the MIB or in the SIB of the cell, the UE determines whether the cell is barred for the indicated cell/network/service type (e.g., NTN service, ATG service, NES operation, LTE service, 5G service, 6G service) based on the cell barring bit. If the cell barring bit is set to “barred” (or alternatively is set to “1” or is absent), the UE is barred access for the indicated cell/network/service type (e.g., NTN service, ATG service, NES operation, LTE service, 5G service, 6G service). If the cell barring bit is set to “not-barred” (or alternatively set to “0” or is absent), the UE is allowed access for the indicated cell/network/service type (e.g., NTN service, ATG service, NES operation, LTE service, 5G service, 6G service). For example:
if 5G service is indicated and if the UE is capable of 5G access, the barring bit in the PBCH payload or in the MIB or in the SIB is to bar 5G UE/connectivity;
if 6G service is indicated and if the UE is capable of 6G access, the barring bit in the PBCH payload or in the MIB or in the SIB is to bar 6G UE/connectivity;
if LTE service is indicated and if the UE is capable of LTE access, the barring bit in the PBCH payload or in the MIB or in the SIB is to bar LTE UE/connectivity;
if NTN service is indicated and if the UE is capable of NTN access, the barring bit in the PBCH payload or in the MIB or in the SIB is to bar NTN UE/connectivity to NTN;
if ATG service is indicated and if the UE is capable of ATG access, the barring bit in the PBCH payload or in the MIB or in the SIB is to bar ATG UE/connectivity to ATG;
if UAV service is indicated and if the UE is capable of ATG access, the barring bit in the PBCH payload or in the MIB or in the SIB is to bar UAV UE/connectivity to a UAV;
if NES service is indicated and if the UE is capable of NES operation, the barring bit in the PBCH payload or in the MIB or in the SIB is to bar an NES-capable UE;
if Redcap service is indicated and if the UE is a Redcap UE with 1RX chain, the barring bit in the PBCH payload or in the MIB or in the SIB is to bar a Redcap UE with 1RX chain;
if Redcap service is indicated and if the UE is Redcap UE with 2RX chain, the barring bit in the PBCH payload or in the MIB or in the SIB is to bar a Redcap UE with 2RX chain;
if eRedcap service is indicated and if the UE is an eRedcap UE with 1RX chain, the barring bit in the PBCH payload or in the MIB or in the SIB is to bar an eRedcap UE with 1RX chain;
if eRedcap service is indicated and if the UE is an eRedcap UE with 2RX chain, the barring bit in the PBCH payload or in the MIB or in the SIB is to bar an eRedcap UE with 2RX chain.

In some embodiments, multiple bits or a bitmap for a cell/network/service type and multiple cell barring bits can be included in a PBCH payload or in a MIB or in a SIB of a cell. Each cell barring bit is used to indicate cell barring for a specific cell/network/service type. If a specific cell/network/service type is indicated in the PBCH payload or in the MIB or in the SIB of the cell, the UE determines whether the cell is barred for the indicated cell/network/service type (e.g., NTN service, ATG service, NES operation, LTE service, 5G service, 6G service) based on the corresponding cell barring bit. If the cell barring bit is set to “barred” (or alternatively set to “1” or absent), the UE is barred access for the indicated cell/network/service type (e.g., NTN service, ATG service, NES operation, LTE service, 5G service, 6G service). If the cell barring bit is set to “not-barred” (or alternatively set to “0” or absent), the UE is allowed access for the indicated cell/network/service type (e.g., NTN service, ATG service, NES operation, LTE service, 5G service, 6G service).

Although FIG. 19 illustrates one example procedure for barring in wireless communication system 1900, various changes may be made to FIG. 19. For example, while shown as a series of steps, various steps in FIG. 19 could overlap, occur in parallel, occur in a different order, occur any number of times, be omitted, or replaced by other steps.

FIG. 20 illustrates another example procedure for barring in wireless communication system 2000 according to embodiments of the present disclosure. An embodiment of the procedure illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a procedure for barring in wireless communication system could be used without departing from the scope of this disclosure.

In the example of FIG. 20, procedure 2000 begins at step 2010. At step 2010, in some embodiments, a UE (such as UE 116 of FIG. 1) receives multiple bits or a bitmap for cell barring in a PBCH payload or in a MIB or in a SIB of a cell. Each of these bits uniquely maps to a different cell/network/service type (e.g., NTN cell, ATG cell, NES cell, LTE cell, 5G cell, 6G cell).

At step 2020, the corresponding bit set to “notbarred” (or alternatively set to 0 or absent) indicates the cell supports the corresponding operations and/or provides the corresponding service (e.g., NTN service, ATG service, NES operation, LTE service, 5G service, 6G service) and a UE capable of this cell/network/service type is allowed to access the cell. The corresponding bit set to “barred” (or alternatively set to 1 or absent) indicates a UE capable of this cell/network/service type is not allowed to access the cell, (i.e., access is barred). For example:
if the cell barring bit for LTE service is set to “notbarred” (or alternatively set to 0 or absent) in the PBCH payload or in the MIB or in the SIB and if the UE is capable of LTE access, the bit indicates the UE is allowed access for LTE service;
if the cell barring bit for LTE service is set to “barred” (or alternatively set to 1 or absent) in the PBCH payload or in the MIB or in the SIB and if the UE is capable of LTE access, the bit indicates the UE is barred access for LTE service;
if the cell barring bit for 5G service is set to “notbarred” (or alternatively set to 0 or absent) in the PBCH payload or in the MIB or in the SIB and if the UE is capable of 5G access, the bit indicates the UE is allowed access for 5G service;
if the cell barring bit for 5G service is set to “barred” (or alternatively set to 1 or absent) in the PBCH payload or in the MIB or in the SIB and if the UE is capable of 5G access, the bit indicates the UE is barred access for 5G service;
if the cell barring bit for 6G service is set to “notbarred” (or alternatively set to 0 or absent) in the PBCH payload or in the MIB or in the SIB and if the UE is capable of 6G access, the bit indicates the UE is allowed access for 6G service;
if the cell barring bit for 6G service is set to “barred” (or alternatively set to 1 or absent) in the PBCH payload or in the MIB or in the SIB and if the UE is capable of 6G access, the bit indicates the UE is barred access for 6G service;
if the cell barring bit for NTN service is set to “notbarred” (or alternatively set to 0 or absent) in the PBCH payload or in the MIB or in the SIB and if the UE is capable of NTN access, the bit indicates the UE is allowed access for NTN service;
if the cell barring bit for NTN service is set to “barred” (or alternatively set to 1 or absent) in the PBCH payload or in the MIB or in the SIB and if the UE is capable of NTN access, the bit indicates the UE is barred access for NTN service;
if the cell barring bit for ATG service is set to “notbarred” (or alternatively set to 0 or absent) in the PBCH payload or in the MIB or in the SIB and if the UE is capable of ATG access, the bit indicates the UE is allowed access for ATG service;
if the cell barring bit for ATG service is set to “barred” (or alternatively set to 1 or absent) in the PBCH payload or in the MIB or in the SIB and if the UE is capable of ATG access, the bit indicates the UE is barred access for ATG service;
if the cell barring bit for UAV service is set to “notbarred” (or alternatively set to 0 or absent) in the PBCH payload or in the MIB or in the SIB and if the UE is capable of UAV access, the bit indicates the UE is allowed access for UAV service;
if the cell barring bit for UAV service is set to “barred” (or alternatively set to 1 or absent) in the PBCH payload or in the MIB or in the SIB and if the UE is capable of UAV access, the bit indicates the UE is barred access for UAV service;
if the cell barring bit for NES operation is set to “notbarred” (or alternatively set to 0 or absent) in the PBCH payload or in the MIB or in the SIB and if the UE is capable of NES operation, the bit indicates the UE is allowed to access the cell;
if the cell barring bit for NES operation is set to “barred” (or alternatively set to 1 or absent) in the PBCH payload or in the MIB or in the SIB and if the UE is capable of NES operation, the bit indicates the UE is barred access to the cell;
if the cell barring bit for a Redcap UE with 1RX chain is set to “notbarred” (or alternatively set to 0 or absent) in the PBCH payload or in the MIB or in the SIB and if the UE is a Redcap UE with 1RX chain, the bit indicates the UE is allowed to access the cell;
if the cell barring bit for a Redcap UE with 1RX chain is set to “barred” (or alternatively set to 1 or absent) in the PBCH payload or in the MIB or in the SIB and if the UE is a Redcap UE with 1RX chain, the bit indicates the UE is barred access to the cell;
if the cell barring bit for a Redcap UE with 2RX chain is set to “notbarred” (or alternatively set to 0 or absent) in the PBCH payload or in the MIB or in the SIB and if the UE is a Redcap UE with 2RX chain, the bit indicates the UE is allowed to access the cell;
if the cell barring bit for a Redcap UE with 2RX chain is set to “barred” (or alternatively set to 1 or absent) in the PBCH payload or in the MIB or in the SIB and if the UE is a Redcap UE with 2RX chain, the bit indicates the UE is barred access to the cell;
if the cell barring bit for an eRedcap UE with 1RX chain is set to “notbarred” (or alternatively set to 0 or absent) in the PBCH payload or in the MIB or in the SIB and if the UE is an eRedcap UE with 1RX chain, the bit indicates the UE is allowed to access the cell;
if the cell barring bit for an eRedcap UE with 1RX chain is set to “barred” (or alternatively set to 1 or absent) in the PBCH payload or in the MIB or in the SIB and if the UE is an eRedcap UE with 1RX chain, the bit indicates the UE is barred access to the cell;
if the cell barring bit for an eRedcap UE with 2RX chain is set to “notbarred” (or alternatively set to 0 or absent) in the PBCH payload or in the MIB or in the SIB and if the UE is an eRedcap UE with 2RX chain, the bit indicates the UE is allowed to access the cell;
if the cell barring bit for an eRedcap UE with 2RX chain is set to “barred” (or alternatively set to 1 or absent) in the PBCH payload or in the MIB or in the SIB and if the UE is an eRedcap UE with 2RX chain, the bit indicates the UE is barred access to the cell.

Although FIG. 20 illustrates one example procedure for barring in wireless communication system 2000, various changes may be made to FIG. 20. For example, while shown as a series of steps, various steps in FIG. 20 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a processor configured to:
segment a paging identity of the UE into a plurality of paging identity segments including at least a first paging identity segment and a second paging identity segment;
determine a paging frame (PF) based on the first paging identity segment; and
determine, based on the second paging identity segment, a paging occasion (PO) of the PF; and
a transceiver operatively coupled to the processor, the transceiver configured to receive, in one of the determined PO or a paging early indication-occasion (PEI-O), a first physical download control channel (PDCCH) transmission including first downlink control information (DCI) addressed to a paging-radio network temporary identifier (P-RNTI).

2. The UE of claim 1, wherein:
the plurality of paging identity segments further includes a third paging identity segment;
the transceiver is further configured to receive, based on scheduling information in the first DCI, a transport block including a paging message; and
the processor is further configured to:
determine whether the paging message includes the third paging identity segment; and
in response to a determination that the paging message includes the third paging identity segment, initiate a paging response.

3. The UE of claim 1, wherein:
the plurality of paging identity segments further includes a third paging identity segment; and
the processor is further configured to:
determine whether the first DCI includes the third paging identity segment; and
in response to a determination that the first DCI includes the third paging identity segment, initiate a paging response.

4. The UE of claim 1, wherein:
the plurality of paging identity segments further includes a third paging identity segment and a fourth paging identity segment;
the processor is further configured to determine whether the first DCI includes the third paging identity segment;
the transceiver is further configured to, in response to a determination that the first DCI includes the third paging identity segment, receive, based on scheduling information in the first DCI, a transport block including a paging message; and
the processor is further configured to:
determine whether the paging message includes the fourth paging identity segment; and
in response to a determination that the paging message includes the fourth paging identity segment, initiate a paging response.

5. The UE of claim 1, wherein:
the plurality of paging identity segments further includes a third paging identity segment and a fourth paging identity segment;
the processor is further configured to:
determine, based on the third paging identity segment, a paging subgroup of the UE; and
determine whether the first DCI indicates paging for the paging subgroup of the UE;
the transceiver is further configured to, in response to a determination that the first DCI indicates the paging subgroup of the UE, receive, based on scheduling information in the first DCI, a transport block including a paging message; and
the processor is further configured to:
determine whether the paging message includes the fourth paging identity segment; and
in response to a determination that the paging message includes the fourth paging identity segment, initiate a paging response.

6. The UE of claim 1, wherein:
the plurality of paging identity segments further includes a third paging identity segment and a fourth paging identity segment;
the processor is further configured to:
determine, based on the third paging identity segment, a paging subgroup of the UE; and
determine whether the first DCI received in the PEI-O indicates paging for the paging subgroup of the UE;
the transceiver is further configured to, in response to a determination that the first DCI indicates paging for the paging subgroup of the UE, receive, a second PDCCH transmission including second DCI in the determined PO; and
the processor is further configured to:
determine whether the second DCI includes the fourth paging identity segment; and
in response to a determination that the second DCI includes the fourth paging identity segment, initiate a paging response.

7. The UE of claim 1, wherein:
the plurality of paging identity segments further includes a third paging identity segment and a fourth paging identity segment;
the processor is further configured to:
determine, based on the third paging identity segment, a paging subgroup of the UE; and
determine whether the first DCI in the PEI-O indicates paging for the paging subgroup of the UE;
the transceiver is further configured to:
in response to a determination that the first DCI indicates paging for the paging subgroup of the UE, receive a second PDCCH transmission including second DCI in the determined PO; and
receive, based on scheduling information in the second DCI, a transport block including a paging message; and
the processor is further configured to:
determine whether the paging message includes the fourth paging identity segment; and
in response to a determination that the paging message includes the fourth paging identity segment, initiate a paging response.

8. A base station (BS) comprising:
a processor configured to:
segment a paging identity of a user equipment (UE) into a plurality of paging identity segments including at least a first paging identity segment and a second paging identity segment;
determine a paging frame (PF) based on the first paging identity segment; and
determine, based on the second paging identity segment, a paging occasion (PO) of the PF; and
a transceiver operatively coupled to the processor, the transceiver configured to transmit, to the UE, in one of the determined PO or a paging early indication-occasion (PEI-O), a first physical download control channel (PDCCH) transmission including first downlink control information (DCI) addressed to a paging-radio network temporary identifier (P-RNTI).

9. The BS of claim 8, wherein:
the plurality of paging identity segments further includes a third paging identity segment;
the transceiver is further configured to:
transmit, to the UE, based on scheduling information in the first DCI, a transport block including a paging message including the third paging identity segment; and
receive, based on the paging message including the third paging identity segment, a paging response from the UE.

10. The BS of claim 8, wherein:
the plurality of paging identity segments further includes a third paging identity segment;
the first DCI includes the third paging identity segment; and
the transceiver is further configured to receive, based on the first DCI including the third paging identity segment, a paging response from the UE.

11. The BS of claim 8, wherein:
the plurality of paging identity segments further includes a third paging identity segment and a fourth paging identity segment;
the first DCI includes the third paging identity segment; and
the transceiver is further configured to:
transmit, to the UE, based on scheduling information in the first DCI, a transport block including a paging message including the fourth paging identity segment; and
receive, based on the paging message including the fourth paging identity segment, a paging response from the UE.

12. The BS of claim 8, wherein:
the plurality of paging identity segments further includes a third paging identity segment and a fourth paging identity segment;
the third paging identity segment indicates a paging subgroup of the UE;
the first DCI indicates paging for the paging subgroup of the UE; and
the transceiver is further configured to:
transmit, based on scheduling information in the first DCI, a transport block including a paging message including the fourth paging identity segment; and
receive, based on the paging message including the fourth paging identity segment, a paging response from the UE.

13. The BS of claim 8, wherein:
the plurality of paging identity segments further includes a third paging identity segment and a fourth paging identity segment;
the third paging identity segment indicates a paging subgroup of the UE;
the first DCI is transmitted in the PEI-O;
the first DCI indicates paging for the paging subgroup of the UE; and
the transceiver is further configured to:
transmit a second PDCCH transmission including second DCI including the fourth paging identity segment in the determined PO; and
receive, based on the second DCI including the fourth paging identity segment, a paging response from the UE.

14. A method of operating user equipment (UE), the method comprising:
segmenting a paging identity of the UE into a plurality of paging identity segments including at least a first paging identity segment and a second paging identity segment;
determining a paging frame (PF) based on the first paging identity segment;
determining, based on the second paging identity segment, a paging occasion (PO) of the PF; and
receiving, in one of the determined PO or a paging early indication-occasion (PEI-O), a first physical download control channel (PDCCH) transmission including first downlink control information (DCI) addressed to a paging-radio network temporary identifier (P-RNTI).

15. The method of claim 14, wherein:
the plurality of paging identity segments further includes a third paging identity segment; and
the method further comprises:
receiving, based on scheduling information in the first DCI, a transport block including a paging message;
determining whether the paging message includes the third paging identity segment; and
in response to a determination that the paging message includes the third paging identity segment, initiating a paging response.

16. The method of claim 14, wherein:
the plurality of paging identity segments further includes a third paging identity segment; and
the method further comprises:
determining whether the first DCI includes the third paging identity segment; and
in response to a determination that the first DCI includes the third paging identity segment, initiating a paging response.

17. The method of claim 14, wherein:
the plurality of paging identity segments further includes a third paging identity segment and a fourth paging identity segment; and
the method further comprises:
determining whether the first DCI includes the third paging identity segment;
in response to a determination that the first DCI includes the third paging identity segment, receiving, based on scheduling information in the first DCI, a transport block including a paging message;
determining whether the paging message includes the fourth paging identity segment; and
in response to a determination that the paging message includes the fourth paging identity segment, initiating a paging response.

18. The method of claim 14, wherein:
the plurality of paging identity segments further includes a third paging identity segment and a fourth paging identity segment; and
the method further comprises:
determining, based on the third paging identity segment, a paging subgroup of the UE;
determining whether the first DCI indicates paging for the paging subgroup of the UE;
in response to a determination that the first DCI indicates the paging subgroup of the UE, receiving, based on scheduling information in the first DCI, a transport block including a paging message;
determining whether the paging message includes the fourth paging identity segment; and
in response to a determination that the paging message includes the fourth paging identity segment, initiating a paging response.

19. The method of claim 14, wherein:
the plurality of paging identity segments further includes a third paging identity segment and a fourth paging identity segment; and
the method further comprises:
determining, based on the third paging identity segment, a paging subgroup of the UE;
determining whether the first DCI received in the PEI-O indicates paging for the paging subgroup of the UE;
in response to a determination that the first DCI indicates paging for the paging subgroup of the UE, receiving, a second PDCCH transmission including second DCI in the determined PO;
determining whether the second DCI includes the fourth paging identity segment; and
in response to a determination that the second DCI includes the fourth paging identity segment, initiating a paging response.

20. The method of claim 14, wherein:
the plurality of paging identity segments further includes a third paging identity segment and a fourth paging identity segment; and
the method further comprises:
determining, based on the third paging identity segment, a paging subgroup of the UE;
determining whether the first DCI in the PEI-O indicates paging for the paging subgroup of the UE;
in response to a determination that the first DCI indicates paging for the paging subgroup of the UE, receiving a second PDCCH transmission including second DCI in the determined PO;
receiving, based on scheduling information in the second DCI, a transport block including a paging message;
determining whether the paging message includes the fourth paging identity segment; and
in response to a determination that the paging message includes the fourth paging identity segment, initiating a paging response.
